(19) United States
(12) Patent Application Publication
(10) Pub. No.: US 2026/0359033 A1
(43) Pub. Date: Nov. 12, 2026

(54) INFORMATION PROCESSING METHOD, ELECTRONIC DEVICE, AND PROGRAM

(71) Applicant: SONY GROUP CORPORATION, TOKYO (JP)

(72) Inventors: YOUTARO MINE, TOKYO (JP); KENTARO IDA, TOKYO (JP)

(21) Appl. No.: 19/475,200

(22) PCT Filed: Apr. 8, 2024
(86) PCT No.: PCT/JP2024/014278

§ 371 Date: Oct. 14, 2025

(30) Foreign Application Priority Data
Apr. 27, 2023 (JP) 2023-073139

(51) Int. Cl. G06F 8/65

(52) U.S. Cl. CPC G06F 8/65

(57) ABSTRACT

The present technology relates to an information processing method, an electronic device, and a program capable of appropriately updating software.

Among the plurality of electronic devices connected, an electronic device to be an update processing device that performs update processing of software of a target device serving as an electronic device to which software is to be updated is determined from among the plurality of electronic devices, and the update processing device performs update processing of software of the target device. The present technology can be applied to update firmware (FW) or the like of various systems to which a plurality of electronic devices can be attached, such as a drone system, for example.

### TECHNICAL FIELD

The present technology relates to an information processing method, an electronic device, and a program, and particularly relates to, for example, an information processing method, an electronic device, and a program capable of appropriately updating software.

### BACKGROUND ART

For example, Patent Document 1 describes a technique for updating firmware (FW) of a camera accessory as a peripheral device of a camera from the camera as a data rewriting apparatus connected to a personal computer (PC).

### CITATION LIST

### Patent Document

Patent Document 1: Japanese Patent Application Laid-Open No. 2005-078343

### SUMMARY OF THE INVENTION

### Problems to be Solved by the Invention

In addition to the system including the PC, the camera, and the camera accessory described in Patent Document 1, a technology capable of appropriately updating the FW and other software of each electronic device has been requested for a system including various electronic devices.

The present technology has been made in view of such a situation, and enables software to be appropriately updated.

### Solutions to Problems

An information processing method of the present technology is an information processing method including: determining, from among a plurality of electronic devices connected, an electronic device to be an update processing device that performs update processing of software of a target device serving as an electronic device to which software is to be updated, in which the update processing device performs update processing of software of the target device.

An electronic device according to the present technology is an electronic device capable of being one of the plurality of electronic devices, the electronic device including a control unit configured to: determine, from among a plurality of electronic devices connected, an electronic device to be an update processing device that performs update processing of software of a target device serving as an electronic device to which software is to be updated; and cause the update processing device to perform update processing of software of the target device.

A program according to the present technology is a program for causing a computer to execute processing of: determining, from among a plurality of electronic devices connected, an electronic device to be an update processing device that performs update processing of software of a target device serving as an electronic device to which software is to be updated; and causing the update processing device to perform update processing of software of the target device.

In the present technology, among the plurality of electronic devices connected, an electronic device to be an update processing device that performs update processing of software of a target device serving as an electronic device to which software is to be updated is determined from among the plurality of electronic devices, and the update processing device performs update processing of software of the target device.

The program can be provided by being transmitted via a transmission medium or by being recorded on a recording medium.

### BRIEF DESCRIPTION OF DRAWINGS

FIG. 1 is a block diagram illustrating a configuration example of an embodiment of an information processing system to which the present technology is applied.

FIG. 2 is a diagram for explaining an outline of processing of a drone system in a case where the information processing system 10 is applied to the drone system and FW of the drone system is updated by firmware over the air (FOTA) as data update.

FIG. 3 is a diagram for explaining an example of a disadvantage that occurs in a case where FW of an electronic device is unconditionally updated.

FIG. 4 is a diagram illustrating an example of a network tree structure.

FIG. 5 is a diagram for explaining an example of updating of FW of an electronic device performed in order from an electronic device serving as a leaf node of a network tree structure to a host device serving as a root node.

FIG. 6 is a block diagram illustrating a configuration example of electronic devices 11 to 14 constituting the information processing system 10.

FIG. 7 is a diagram for explaining an example of update processing of the FW of the accessory A in a case where the information processing system 10 includes the host device and the accessory A.

FIG. 8 is a diagram for explaining an example of a process of updating the FW of the accessories A to C in a case where the information processing system 10 includes the host device and the accessories A to C.

FIG. 9 is a flowchart for explaining an example of a process of updating the FW of the electronic device performed by the information processing system 10.

FIG. 10 is a diagram for explaining an example of a specific process of the network tree structure in step S201.

FIG. 11 is a diagram illustrating an example of a device list generated by specifying the network tree structure in step S201.

FIG. 12 is a diagram illustrating an example of a network tree structure specified by specification of the network tree structure in step S201.

FIG. 13 is a flowchart for explaining an example of specific processing of the network tree structure in step S201.

FIG. 14 is a diagram illustrating an example of a version table stored in the data server 23.

FIG. 15 is a flowchart for explaining an example of a process of specifying a combination of versions of FW that can be used in combination in step S203.

FIG. 16 is a diagram for explaining an example of processing of selecting an attention row in step S223 and specifying a combination of versions of FW that can be used in combination in step S227.

FIG. 17 is a diagram for explaining another example of the process of selecting the attention row in step S223 and specifying the combination of versions of FW that can be used in combination in step S227.

FIG. 18 is a flowchart for explaining an example of a process of updating the FW based on the specified combination in step S204.

FIG. 19 is a flowchart for explaining a first example of a process of updating the FW of the target device in step S235.

FIG. 20 is a flowchart for explaining a second example of a process of updating the FW of the target device in step S235.

FIG. 21 is a block diagram illustrating a configuration example of an embodiment of a computer to which the present technology is applied.

### MODE FOR CARRYING OUT THE INVENTION

### Configuration Example of Information Processing System to Which Present Technology Is Applied

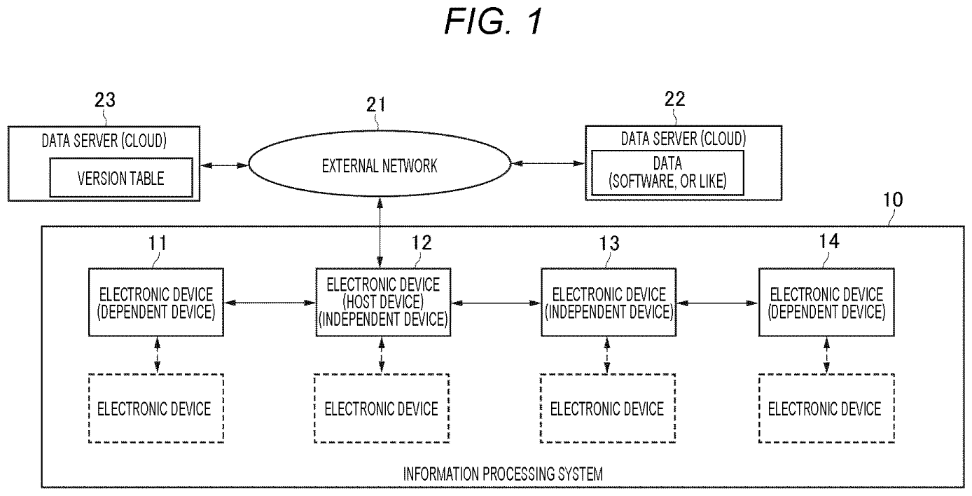

FIG. 1 is a block diagram illustrating a configuration example of an embodiment of an information processing system to which the present technology is applied.

In FIG. 1, an information processing system 10 includes four electronic devices 11, 12, 13, and 14 as a plurality of electronic devices. Note that the number of electronic devices constituting the information processing system 10 is not limited to four, and any number of two, three, or five or more can be adopted.

Each electronic device constituting the information processing system 10 is configured to be connectable to at least one other electronic device. The electronic device constituting the information processing system 10 is connected to another electronic device in such a manner that signals (data) can be directly exchanged with the other electronic device unless otherwise specified. As a connection method between the electronic devices, for example, any communication method such as wired communication such as a universal serial bus (USB) or wireless communication such as a wireless local area network (LAN) can be adopted.

In FIG. 1, the electronic device 11 and the electronic device 12 are connected, the electronic device 12 and the electronic device 13 are connected, and the electronic device 13 and the electronic device 14 are connected. Note that the electronic devices 11 to 14 can be configured to be further connectable to other electronic devices as indicated by dotted lines in the figure.

Each of the electronic devices 11 to 14 constituting the information processing system 10 stores internal data for exerting its function.

Among the electronic devices 11 to 14 constituting the information processing system 10, for example, the electronic device 12 can perform communication via an external network 21 such as the Internet. For example, the electronic device 12 can communicate with a data server 22 and a data server 23 via the external network 21.

The data server 22 is, for example, a server on a cloud, and stores internal data of various versions as internal data of various electronic devices.

The data server 23 is, for example, a server on a cloud, and stores a version table that manages versions of internal data stored in the data server 22.

The electronic device 12 downloads the version table by communicating with the data server 23, and uses the version table to specify the versions of the internal data that can be used in combination in the electronic devices 11 to 14 constituting the information processing system 10. The electronic device 12 downloads the internal data of the specified version by communicating with the data server 22, and the internal data of the electronic device constituting the information processing system 10 is updated by the internal data.

The internal data of the electronic device is various data such as a setting value for controlling the operation of the electronic device and software (program) executed by the electronic device. The software executed by the electronic device includes a firmware (FW), an operating system (OS), and the like in addition to the application program.

Regarding the update of the internal data, the electronic device 11 has a function as a dependent device, and the electronic device 12 has a function as a host device and an independent device. The electronic device 13 has a function as an independent device, and the electronic device 14 has a function as a dependent device.

The host device is an electronic device capable of communicating with the external network 21, and is an electronic device directly or indirectly connected to another electronic device constituting the information processing system 10. Another electronic device directly or indirectly connected to the host device is also referred to as an accessory.

The independent device is an electronic device in which the electronic device itself can perform update processing of updating internal data of the electronic device (itself).

The dependent device is an electronic device that cannot perform update processing on the internal data of the electronic device and needs to be updated by another electronic device (update of the internal data needs to be controlled). That is, the dependent device is an electronic device in which the internal data update processing is performed by another electronic device.

An electronic device whose internal data is to be updated is also referred to as a target device, and an electronic device that performs update processing of the internal data of the target device is also referred to as an update processing device. In a case where the independent device becomes the target device, the independent device becomes an update processing device that performs update processing of its own internal data. In a case where the dependent device is the target device, the independent device capable of performing the update processing on the internal data of the dependent device is the update processing device.

Hereinafter, software executed by the electronic device, for example, firmware (FW) is adopted as the internal data of the electronic device.

The FW of the electronic device is updated by newly writing the FW in the FW storage area in which the FW of the electronic device is to be stored. In the FW update processing, it is necessary to temporarily store a FW file (image file) storing an image of the FW to be written in the FW storage area, and perform control to write the FW stored in the temporarily stored FW file in the FW storage area. Therefore, the electronic device (independent device) capable of performing the update processing of the FW includes a storage unit having a file system (FS) that manages storage of files. On the other hand, the electronic device not including the storage unit including the FS is a dependent device.

Here, for example, in a camera system including a camera body, an accessory, for example, an interchangeable lens, and an intermediate accessory mounted between the camera body and the interchangeable lens, for example, the camera body is a host device and an independent device, and each accessory is connected in parallel to the camera body with each accessory of the interchangeable lens and the intermediate accessory as a dependent device. Then, the camera body performs update processing of the FW of each accessory. The accessory is thus limited to the dependent device. Furthermore, the network topology of the camera body and each accessory is limited to a star network topology centered on the camera body that is a host device (and an independent device).

In the information processing system 10, among the plurality of electronic devices constituting the information processing system 10, an electronic device serving as an update processing device that performs update processing for the FW of a target device serving as an electronic device whose FW is to be updated is determined from among the plurality of electronic devices constituting the information processing system 10. Then, the update processing device performs update processing of the FW of the target device. As a result, in the information processing system 10, even if the electronic device constituting the information processing system 10 is either the independent device or the dependent device, the FW as the internal data of the electronic device can be appropriately updated.

That is, in the information processing system 10, when there is one or more electronic devices that can be the host device, the other electronic devices can update the FW of the electronic device regardless of whether the electronic device is the independent device or the dependent device. However, in the information processing system 10, in a case where there is a dependent device among the electronic devices, the information processing system 10 needs to include an electronic device as an independent device that functions as an update processing device capable of updating the FW of the dependent device. Therefore, if the information processing system 10 includes an electronic device that functions as a host device and as an independent device that functions as an update processing device of any dependent device, the other electronic device can update the FW of the electronic device regardless of whether the other electronic device is the independent device or the dependent device. For example, in the information processing system 10, an electronic device serving as an independent device that functions as a host device and functions as an update processing device of any dependent device can be adopted as the electronic device 12.

In addition, the information processing system 10 can update the FW of the electronic device regardless of the network topology of the electronic device. Furthermore, the information processing system 10 can update the FW of the electronic device regardless of the position of the host device in the network topology of the electronic device.

### Drone System to Which Information Processing System 10 Is Applied

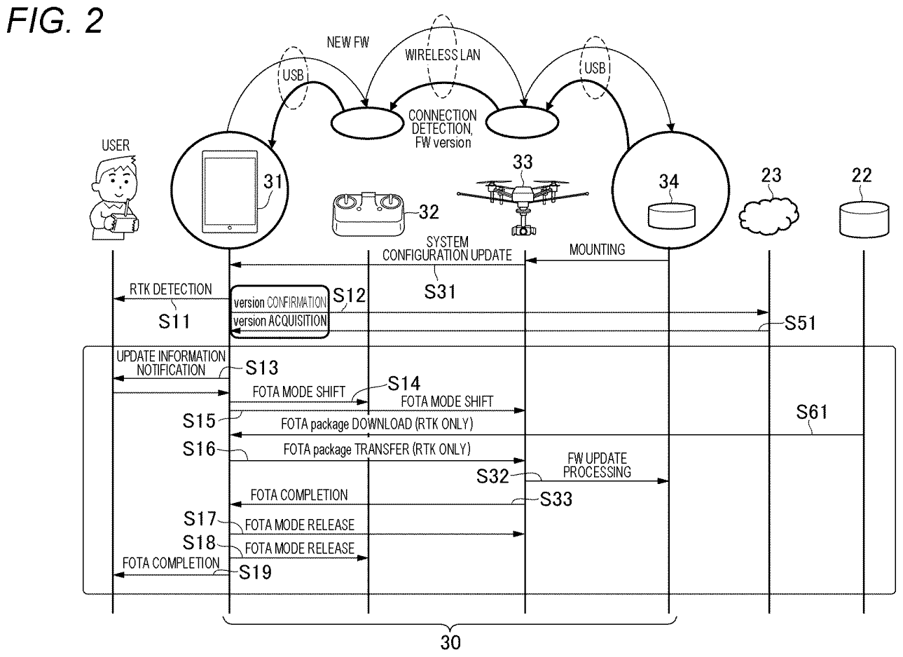

FIG. 2 is a diagram for explaining an outline of processing of the drone system in a case where the information processing system 10 is applied to the drone system and FW of the drone system is updated by firmware over the air (FOTA) as data update.

In FIG. 2, the drone system 30 includes a tablet 31, a transmitter 32, a drone 33, and a real time kinematic (RTK) 34 as a plurality of electronic devices.

The tablet 31 has functions as a host device and an independent device, and the transmitter 32 and the drone 33 have functions as independent devices. The RTK 34 has a function as a dependent device. The drone 33 of the independent device also functions as an update processing device for the RTK 34 of the dependent device.

The tablet 31 and the transmitter 32 are connected by, for example, a USB. The transmitter 32 and the drone 33 are connected by, for example, a wireless LAN such as Wi-Fi (registered trademark). The drone 33 and the RTK 34 are connected by USB, for example.

For example, when the RTK 34 is attached to the drone 33 and the drone 33 and the RTK 34 are connected, in step S31, the drone 33 transmits a system configuration update message indicating that the configuration of the drone system 30 has been updated by the attachment of the RTK 34 to the tablet 31 via the transmitter 32.

The tablet 31 receives a system configuration update message from the drone 33. The tablet 31 detects the connection of the RTK 34 by the system configuration update message from the drone 33.

In response to the system configuration update message, the tablet 31 presents the detection of the RTK 34 to the user by displaying or the like in step S11. Further, in response to the system configuration update message, in step S12, the tablet 31 accesses the data server 23 to confirm the version of the FW applied to the RTK 34. In response to the access from the tablet 31, the data server 23 transmits the version table to the tablet 31 in step S51. The tablet 31 acquires the version table by receiving the version table from the data server 23.

The tablet 31 uses the version table to check whether the current version of the FW in the RTK 34 is the latest version appropriate for the drone system 30. In a case where the current version of the FW in the RTK 34 is an appropriate latest version, subsequent processing is skipped.

In a case where the current version of the FW in the RTK 34 is not the latest appropriate version, that is, in a case where the current version of the FW in the RTK 34 is an old (or inappropriate) version, the tablet 31 notifies (presents) the user of the update information indicating that the FW in the RTK 34 is to be updated in step S13, for example, by displaying the update information.

When the user operates the tablet 31 so as to agree to the update of the FW in response to the notification of the update information, the tablet 31 transmits, to the transmitter 32, in step S14, a FOTA mode shift message instructing to shift the operation mode to the FOTA mode in which the FW is updated by FOTA. Further, in step S15, the tablet 31 transmits a FOTA mode shift message to the drone 33 via the transmitter 32. The transmitter 32 and the drone 33 shift the operation mode to the FOTA mode in response to the FOTA mode shift message.

Thereafter, the tablet 31 requests the data server 22 for a FOTA package that is a package of FW of an appropriate latest version of the RTK 34 updated by FOTA. In step S61, the data server 22 transmits the FOTA package according to the request from the tablet 31 to the tablet 31.

The tablet 31 receives the FOTA package from the data server 22. In response to the reception of the FOTA package, the tablet 31 transmits (transfers) the FOTA package to the drone 33 via the transmitter 32 in step S16.

The drone 33 receives the FOTA package from the tablet 31. In step S32, the drone 33 temporarily stores the FOTA package from the tablet 31, that is, the package of the FW of the appropriate latest version of the RTK 34, and performs an FW update processing of updating the FW of the RTK 34 by the package of the FW.

When the update processing of the FW of the RTK 34 ends, the drone 33 transmits a FOTA completion message indicating that the update processing of the FW of the RTK 34 ends to the tablet 31 via the transmitter 32.

The tablet 31 receives a FOTA completion message from the drone 33. In response to the reception of the FOTA completion message, in step S17, the tablet 31 transmits a FOTA mode release message instructing release of the FOTA mode to the drone 33 via the transmitter 32. Further, in step S18, the tablet 31 transmits a FOTA mode release message to the transmitter 32. In response to the FOTA mode release message, the transmitter 32 and the drone 33 shift the operation mode from the FOTA mode to the original mode.

Thereafter, in step S19, the tablet 31 presents information indicating that the update of the FW of the RTK 34 by the FOTA has been completed (information indicating that the FOTA has been completed) to the user.

Note that, here, in a case where the RTK 34 is mounted on the drone 33 and the connection of the RTK 34 is detected, the FW of the RTK 34 is updated, but the FW can be updated at an arbitrary timing for an arbitrary electronic device. That is, in the drone system 30, the electronic device connected as the drone system 30 is detected (connection detection) at an arbitrary timing, and the version of the FW of the detected electronic device can be confirmed. Then, the necessary FW of the electronic device can be updated to an appropriate latest version of FW (new FW) according to the confirmation result of the version of FW.

The information processing system 10 can be applied to, for example, various systems in addition to the drone system 30 illustrated in FIG. 2. For example, the information processing system 10 can be applied to various systems to which a plurality of electronic devices can be attached, such as various robot systems such as a pet type robot and a humanoid robot, and a vehicle system to which a driving automation system is applied.

### Inconvenience That Occurs in Case Where FW of Electronic Device Is Updated

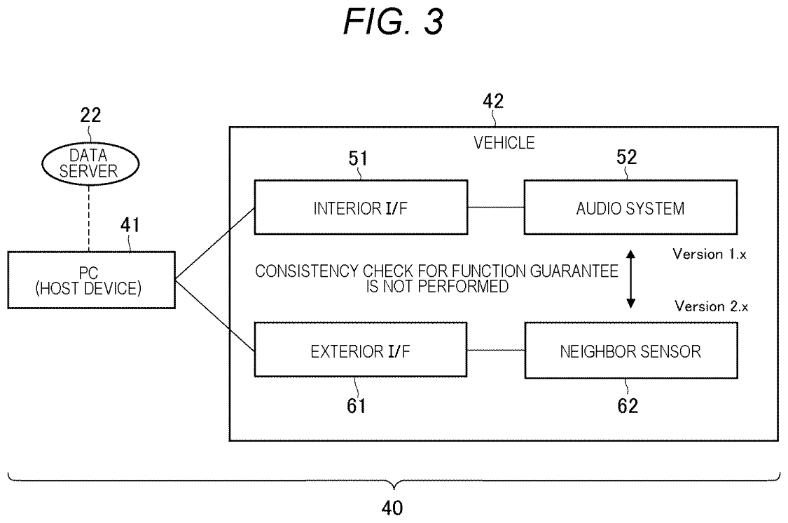

FIG. 3 is a diagram for explaining an example of a disadvantage that occurs in a case where the FW of the electronic device is unconditionally updated.

FIG. 3 is a block diagram illustrating a configuration example of a vehicle system 40 to which the information processing system 10 can be applied.

The vehicle system 40 includes a PC 41 and a vehicle 42.

The PC 41 has a function as a host device.

The vehicle 42 includes an interior interface (I/F) 51, an audio system 52, an exterior I/F 61, and a proximity sensor 62.

The interior interface (I/F) 51 has a function as an independent device, and the audio system 52 has a function as a dependent device. An accessory (device) of the interior of the vehicle 42 such as the audio system 52 can be connected to the interior I/F 51. The interior I/F 51 of the independent device also functions as an update processing device of a dependent device such as the audio system 52 connected to the interior I/F 51.

The exterior I/F 61 has a function as an independent device, and the proximity sensor 62 has a function as a dependent device. An exterior accessory such as the proximity sensor 62 of the vehicle 42 can be connected to the exterior I/F 61. The exterior I/F 61 of the independent device also functions as an update processing device of a dependent device such as the proximity sensor 62 connected to the exterior I/F 61.

In the vehicle system 40, the PC 41 is connected to each of the interior I/F 51 and the exterior I/F 61 of the vehicle 42.

Since the PC 41, the interior I/F 51, the audio system 52, the exterior I/F 61, and the proximity sensor 62 are electronic devices, the vehicle system 40 is configured by connecting a plurality of electronic devices.

In a case where the new version of the FW of the interior or the exterior of the vehicle 42 is released, the PC 41 of the host device downloads the new version of the FW of the interior or the exterior from the data server 22, and transmits the new version to the interior I/F 51 or the exterior I/F 61.

The interior I/F 51 of the update processing device performs update processing of updating the FW of the interior such as the audio system 52 according to the new version of the FW of the interior from the PC 41. Similarly, the exterior I/F 61 of the update processing device performs update processing of updating the FW of the exterior such as the proximity sensor 62 with the new version of the FW of the exterior from the PC 41.

Here, regarding a plurality of connected electronic devices, normal operation of a function of each electronic device in a relationship with another electronic device is also referred to as functional consistency, and guarantee of functional consistency is also referred to as functional guarantee. The combination of the FW and other software of the plurality of electronic devices is desirably a combination in which the function is guaranteed, but even if the function is not guaranteed, it is only necessary that (as a result) the function is consistent. Therefore, a combination (FW) in which the function is guaranteed appearing in the following description can be read as a combination (FW) in which the function is consistent.

The interior I/F 51 performs various types of management including version management of the FW of the interior other than the audio system 52 connected to the interior I/F 51. Therefore, the interior I/F 51 can perform a (consistency) check such that a combination of FW versions of a plurality of interiors such as the audio system 52 connected to the interior I/F 51 is a combination in which the function is guaranteed. Then, in the interior I/F 51, in a case where the combination of the versions of the FW of the plurality of interiors is not a combination in which the function is guaranteed by the update of the FW of an arbitrary interior as a result of the check, the update of the FW can be restricted.

Similarly, the exterior I/F 61 performs various types of management including version management of the proximity sensor 62 connected to the exterior I/F 61 and the FW of the exterior. Therefore, the exterior I/F 61 can perform a check so that the combination of the versions of the plurality of exterior FW such as the proximity sensor 62 connected to the exterior I/F 61 is a combination in which the function is guaranteed. Then, in the exterior I/F 61, as a result of the check, in a case where the combination of the versions of the plurality of exterior FW is not a combination in which the function is guaranteed by the update of the FW of any exterior, the update of the FW can be restricted.

However, in the above check, a combination of the version of the FW of the interior and the version of the FW of the exterior is not checked. Therefore, for example, in a case where the FW of the proximity sensor 62 that is an exterior is updated to a new version of the FW, even in a case where the combination of the versions of the plurality of exterior FW including the proximity sensor 62 is a combination in which the function is guaranteed, the combination of the version of the FW of the proximity sensor 62 that is an exterior and the version of the FW of the audio system 52 that is an interior may not be a combination in which the function is guaranteed. In this case, some or all of the functions of one of the audio system 52 and the proximity sensor 62 may not normally operate in relation to the other. For example, in a case where the proximity sensor 62 detects the proximity of an object to the vehicle 42, there may be a disadvantage that the audio system 52 does not output a warning sound.

As described above, when the FW of the electronic device is unconditionally updated to a new version of FW, a combination of FW of a plurality of electronic devices may be a combination of versions of FW of which functions are not guaranteed. In this case, there may be a disadvantage that a function of a certain electronic device does not normally operate in relation to another electronic device.

The information processing system 10 specifies the combination of the versions of the FW for which the function is guaranteed as the combination of the versions of the FW that can be used in combination in the electronic devices 11 to 14 on the basis of the electronic devices 11 to 14 constituting the information processing system 10. Then, the information processing system 10 updates the FW of the electronic device so that the combination of the specified versions is obtained.

As a result, the information processing system 10 can appropriately update the FW as the internal data of the electronic device. That is, the combination of the FW of the plurality of electronic devices constituting the information processing system 10 becomes the combination of the versions of the FW in which the function is not guaranteed, and the FW of the electronic device can be updated by preventing the occurrence of the inconvenience that the function of a certain electronic device does not normally operate in relation to another electronic device.

In addition, in a case where the network topology of the electronic device constituting the information processing system 10 is expressed by a tree structure (hereinafter, also referred to as a network tree structure) in which the host device is a root node, the information processing system 10 updates the FW of the electronic device in the order from the electronic device serving as a leaf node of the network tree structure toward the host device serving as the root node.

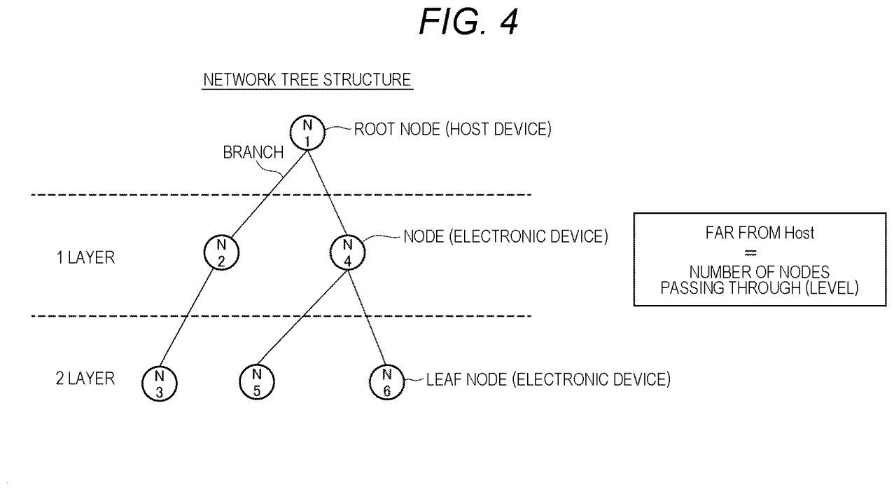

FIG. 4 is a diagram illustrating an example of a network tree structure.

In the network tree structure of FIG. 4, a root node (a node of the highest layer (0th layer) ) N1 represents a host device. Each of the nodes N2 and N3 in the first layer connected to the node N1 by the branch (link) represents an electronic device connected (performing direct communication) to the host device represented by the node N1. A node N3 of the second layer connected to the node N2 by the branch represents an electronic device connected to the electronic device represented by the node N2. Nodes N5 and N6 in the second layer connected to the node N4 by the branch each represent an electronic device connected to the electronic device represented by the node N4. The nodes N3, N5, and N6 are leaf nodes (nodes having no lower layer nodes). The hierarchy of nodes is equal to the number of branches from that node to the root node.

In a case where the information processing system 10 includes, for example, the electronic device having the network tree structure in FIG. 4, in the update of the FW of the electronic device performed in order from the electronic device serving as the leaf node of the network tree structure to the host device serving as the root node, first, the FW of the electronic device represented by the leaf nodes N3, N5, and N6 is updated. The update order of the FW of the electronic device represented by the nodes N3, N5, and N6 is arbitrary.

Thereafter, the FW of the electronic device represented by the node N2 one level higher from the leaf node N3 toward the root node N1 and the FW of the electronic device represented by the node N4 one level higher from the leaf nodes N5 and N6 toward the root node N1 are updated. Note that the update order of the FW of the electronic device indicated by the nodes N2 and N4 is arbitrary.

Finally, the FW of the electronic device represented by the node N1 one level higher from the nodes N2 and N4 toward the root node N1 is updated.

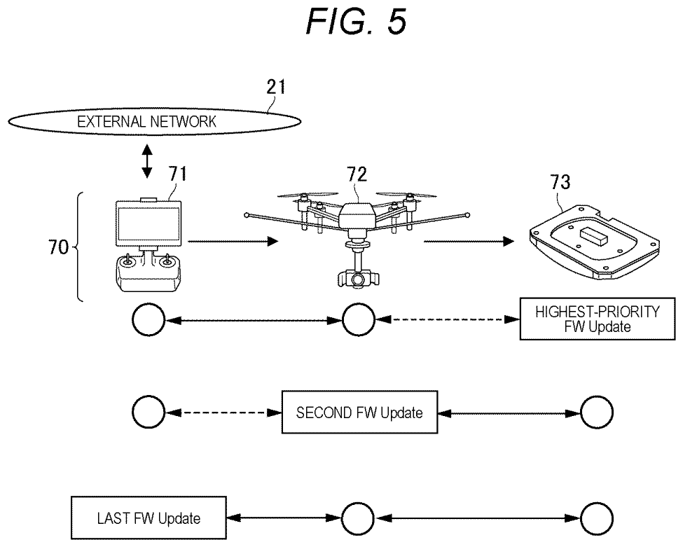

FIG. 5 is a diagram for explaining an example of the update of the FW of the electronic device performed in order from the electronic device serving as the leaf node of the network tree structure to the host device serving as the root node.

FIG. 5 illustrates the order of update of FW in a case where the information processing system 10 is applied to the drone system and the FW of the drone system is updated by FOTA.

In FIG. 5, the drone system 70 includes a transmitter 71, a drone 72, and an RTK 73. The transmitter 71 to the RTK 73 correspond to the electronic devices 12 to 14 of the information processing system 10, respectively. Therefore, the transmitter 71 is a host device and an independent device, and the drone 72 is an independent device. The RTK 73 is a dependent device.

The transmitter 71 performs wireless communication with the drone 72 to control the drone 72. The drone 72 operates according to the control of the transmitter 71. The RTK 73 is an accessory mounted on the drone 72 and used to correct positioning information by a global navigation satellite system (GNSS).

In the network tree structure in which the transmitter 71, which is the host device of the drone system 70, is the root node, the transmitter 71 to the RTK 73 are connected in that order, that is, the order of the transmitter 71, the drone 72, and the RTK 73 as viewed from the transmitter 71 of the root node.

Therefore, the update (hereinafter, also referred to as updating of FW from a leaf node) of the FW of the electronic device performed in order from the leaf node to the root node of the network tree structure is performed in order of the RTK 73, the drone 72, and the transmitter 71.

Here, before the update of the FW, it is assumed that communication between the transmitter 71 and the drone 72 and communication between the drone 72 and the RTK 73 are guaranteed, that is, communication can be normally performed. In addition, in the FW of the transmitter 71 to the RTK 73, it is assumed that the communication guarantee is verified between the versions of the FW having the same number (version number). Therefore, for example, in a case where the FW of each of the transmitter 71 to the RTK 73 is the FW of version 1, communication between the transmitter 71 and the drone 72 and communication between the drone 72 and the RTK 73 are guaranteed. In this case, when, for example, only the FW of the transmitter 71 is updated from version 1 to version 2 among the transmitter 71 to the RTK 73, communication is guaranteed for communication between the drone 72 and the RTK 73, but communication is not guaranteed for communication between the transmitter 71 and the drone 72, and communication between the transmitter 71 and the drone 72 may not be possible.

Now, the FW of the transmitter 71 to the RTK 73 are all version 1 FW, and the version 1 FW of the transmitter 71 to the RTK 73 is updated to version 2 FW.

In this case, in the drone system 70, when the update of the FW is performed in an arbitrary order instead of the update of the FW from the leaf node, there is a possibility that the drone system 70 becomes unavailable.

In the drone system 70, the transmitter 71, which is a host device, downloads the FW of version 2 of the transmitter 71 to the RTK 73 from the data server 22 via the external network 21. Further, the transmitter 71 transmits the FW of version 2 of the drone 72 and the RTK 73 to the drone 72, and the drone 72 transmits the FW of version 2 of the RTK 73 to the RTK 73. In the transmitter 71 to the RTK 73, after the FW of version 2 is obtained, the FW of version 1 is updated to the FW of version 2.

In this case, for example, when the FW of version 1 of the transmitter 71 is first updated to the FW of version 2, communication between the transmitter 71 of the FW of version 2 and the drone 72 of the FW of version 1 is not guaranteed. For this reason, there is a possibility that communication cannot be performed between the transmitter 71 and the drone 72. In a case where communication cannot be performed between the transmitter 71 and the drone 72, the transmitter 71 cannot transmit the FW of version 2 of the drone 72 and the RTK 73 to the drone 72. Therefore, the drone 72 and the RTK 73 cannot update the FW of version 2. As a result, the drone system 70 may become unusable.

On the other hand, in the drone system 70, in a case where the FW from the leaf node is updated, the FW of version 2 of the RTK 73 is first transmitted from the transmitter 71 to the drone 72, and further transmitted from the drone 72 to the RTK 73. Then, in the RTK 73, the FW of version 1 is updated to the FW of version 2 (highest-priority FW Update). In this case, communication between the drone 72 of the FW of version 1 and the RTK 73 of the FW of version 2 is not guaranteed, and there is a possibility that communication cannot be performed as indicated by double-headed arrows of dotted lines in the figure. However, communication is guaranteed between the transmitter 71 of the version 1 FW and the drone 72 of the version 1 FW, and communication can be performed.

In the update of the FW from the leaf node, the FW of version 2 of the drone 72 is transmitted from the transmitter 71 to the drone 72 after the update of the FW of the RTK 73. Then, in the drone 72, the FW of version 1 is updated to the FW of version 2 (second FW Update). In this case, the communication between the transmitter 71 of the FW of version 1 and the drone 72 of the FW of version 2 is not guaranteed, and there is a possibility that communication cannot be performed as indicated by double-headed arrows of dotted lines in FIG. 2. However, between the drone 72 of the FW of version 2 and the RTK 73 of the FW of version 2, communication is guaranteed from a state in which communication is not guaranteed, and communication can be performed.

Thereafter, in the update of the FW from the leaf node, the FW of version 1 is updated to the FW of version 2 in the transmitter 71 (last FW Update). In this case, between the transmitter 71 of the FW of version 2 and the drone 72 of the FW of version 2, the communication is guaranteed from the state in which the communication is not guaranteed, and the communication can be performed.

As described above, in the update of the FW from the leaf node, even after the FW of a certain electronic device is updated, communication is guaranteed from the host device to the electronic device on the host device side of only one electronic device in which the FW is updated. Furthermore, communication from the electronic device in which the FW is updated to the electronic device serving as a leaf node is also guaranteed. As a result, when the update of all the FW of the transmitter 71 to the RTK 73 is completed by the update of the FW from the leaf node, the state between the transmitter 71 and the drone 72 and the state between the drone 72 and the RTK 73 are restored to the state in which the communication is guaranteed. Thus, the drone system 70 can be prevented from becoming unavailable.

Furthermore, for example, in the FW of the transmitter 71 to the RTK 73, in a case where the communication guarantee is verified between the FW of the same number version, by updating the FW from the leaf node, it is guaranteed that all of the transmitter 71 to the RTK 73 can be updated to the FW of the same number version in which the communication guarantee is provided. Therefore, in the development of the FW of the transmitter 71 to the RTK 73, it is only necessary to verify the communication guarantee between the versions of the FW having the same number, and it is not necessary to verify the communication guarantee between the versions of the FW having different numbers. That is, for example, it is not necessary to verify the communication guarantee between the FW of version 1 of the transmitter 71 and the FW of version 2 of the drone 72. As a result, it is possible to reduce labor required for developing a new version of FW.

### CONFIGURATION EXAMPLE OF ELECTRONIC DEVICES 11 to 14

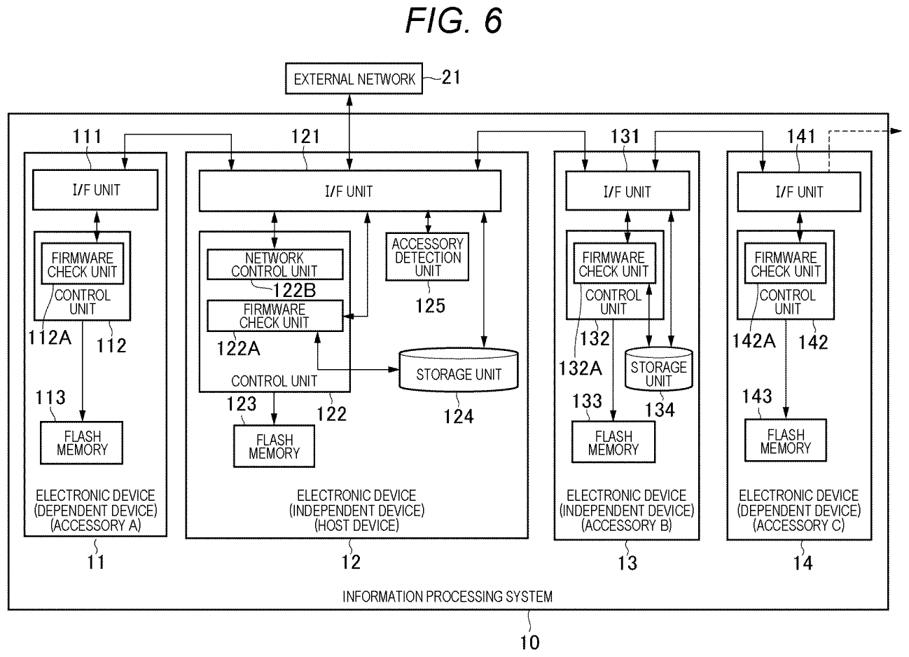

FIG. 6 is a block diagram illustrating a configuration example of the electronic devices 11 to 14 constituting the information processing system 10 in FIG. 1.

Note that, in FIG. 6, parts not related to the update of the FW of the electronic devices 11 to 14 are not illustrated.

The electronic device 11 includes an I/F unit 111, a control unit 112, and a flash memory 113.

The I/F unit 111 is an I/F for exchanging signals (data) with another electronic device connectable to the electronic device 11, for example, the electronic device 12. For example, the I/F unit 111 receives FW of the electronic device 11 transmitted from the electronic device 12, and supplies the FW to the control unit 112. In addition, the I/F unit 111 receives messages as various commands from the electronic device 12 and supplies the messages to the control unit 112. Further, the I/F unit 111 transmits a message as a response to the message as a command under the control of the control unit 112.

The control unit 112 includes a firmware check unit 112A, and performs control regarding update of the FW stored in the flash memory 113 in accordance with a message as a command from the I/F unit 111. For example, the control unit 112 receives the FW supplied from the I/F unit 111, and causes the firmware check unit 112A to perform a security check of the FW. The control unit 112 updates the FW of the electronic device 11 by writing the FW for which the security check has been normally completed by the firmware check unit 112A into the flash memory 113 serving as the FW storage area.

The flash memory 113 stores FW of the electronic device 11.

Since the electronic device 11 is not provided with a storage unit that temporarily stores the file of FW to be written in the flash memory 113, the electronic device 11 is a dependent device. The update processing of updating the FW of the electronic device 11 of the dependent device is performed by an independent device, for example, the electronic device 12 serving as an update processing device.

The electronic device 12 includes an I/F unit 121, a control unit 122, a flash memory 123, a storage unit 124, and an accessory detection unit 125.

The I/F unit 121 is an I/F for exchanging signals with another electronic device connectable to the electronic device 11, for example, the electronic device 11 or the electronic device 13. Further, the I/F unit 121 is also an I/F for performing communication via the external network 21. For example, the I/F unit 121 receives (downloads) the FW of the electronic devices 11 to 14 from the data server 22 via the external network 21. In addition, the I/F unit 121 receives the version table from the data server 23 via the external network 21. Further, the I/F unit 121 transmits the FW from the data server 22 to the electronic device 11 or the electronic device 13 connected to the electronic device 12, and supplies the version table from the data server 23 to the control unit 122. In addition, the I/F unit 121 supplies the FW from the data server 22 to the storage unit 124. In addition, the I/F unit 121 receives a message as a response from the electronic device 11 or the like, and supplies the message to the control unit 122 or the accessory detection unit 125. Further, the I/F unit 121 transmits a message as a command under the control of the control unit 122.

The control unit 122 includes a firmware check unit 122A and a network control unit 122B. The control unit 122 performs control related to update of the FW stored in the flash memory 123. For example, the control unit 122 reads the FW stored in the storage unit 124, and causes the firmware check unit 122A to perform a security check of the FW. The control unit 122 updates the FW of the electronic device 12 by writing the FW for which the security check has been normally completed by the firmware check unit 122A into the flash memory 123 serving as the FW storage area.

The electronic device 12 can function as an update processing device for a dependent device among electronic devices (electronic devices directly or indirectly connected to the electronic device 12) that can constitute the information processing system 10. For example, in a case where the electronic device 12 functions as an update processing device of the electronic device 11 of the dependent device, the I/F unit 121 supplies the FW of the electronic device 11 from the data server 22 to the storage unit 124 to temporarily store the FW. The control unit 122 reads the FW stored in the storage unit 124, and causes the I/F unit 121 to transmit the FW to the electronic device 11. Furthermore, the control unit 122 controls the electronic device 11 to write (update) the FW via the I/F unit 121.

In addition, the control unit 122 causes the network control unit 122B to control communication via the external network 21 by the I/F unit 121. As a result, the control unit 122 causes the I/F unit 121 to download the FW of the electronic devices 11 to 14 from the data server 22 or download the version table from the data server 23.

The flash memory 123 stores FW of the electronic device 12.

The storage unit 124 is a storage unit (a storage unit managed by the FS) including the FS, and temporarily stores the FW supplied from the I/F unit 121 in the form of a file.

The accessory detection unit 125 detects an electronic device as an accessory directly or indirectly connected to the electronic device 12 of the host device. For example, the accessory detection unit 125 controls the I/F unit 121 to cause the I/F unit 121 to exchange data with an electronic device connected to the electronic device 12, and detects the electronic device as an accessory directly or indirectly connected to the electronic device 12 on the basis of the data.

Since the electronic device 12 can perform communication via the external network 21, it is a host device. In addition, since the electronic device 12 is provided with the storage unit 124 that temporarily stores the file of FW to be written in the flash memory 123, the electronic device 11 is an independent device. The electronic device 12 of the independent device can perform update processing of the FW of the electronic device 12 itself and can also perform update processing of the FW of a dependent device, for example, the electronic device 11 or the like as an update processing device.

The electronic device 13 includes an I/F unit 131, a control unit 132, a flash memory 133, and a storage unit 134.

The I/F unit 131 is an I/F for exchanging signals with another electronic device connectable to the electronic device 13, for example, the electronic device 12 or the electronic device 14. For example, the I/F unit 131 receives the FW of the electronic device 13 or the electronic device 14 transmitted from the electronic device 12, and supplies the FW to the storage unit 134. In addition, the I/F unit 131 receives a message as a command from the electronic device 12 and supplies the message to the control unit 132. Further, the I/F unit 131 transmits a message as a command and transmits a message as a response to the message as the command under the control of the control unit 132.

The control unit 132 includes a firmware check unit 132A, and performs control regarding update of the FW stored in the flash memory 133 in accordance with a message as a command from the I/F unit 131. For example, the control unit 132 reads the FW stored in the storage unit 134, and causes the firmware check unit 132A to perform a security check of the FW. The control unit 132 updates the FW of the electronic device 13 by writing the FW for which the security check has been normally completed by the firmware check unit 132A into the flash memory 133 serving as the FW storage area.

The electronic device 13 is an independent device that can constitute the information processing system 10, and can function as an update processing device of the electronic device 14 connected to the electronic device 13. In a case where the electronic device 13 functions as an update processing device of the electronic device 14 of the dependent device, the I/F unit 131 supplies the FW of the electronic device 14 from the electronic device 12 to the storage unit 134 to temporarily store the FW. The control unit 132 reads the FW stored in the storage unit 134, and causes the I/F unit 131 to transmit the FW to the electronic device 14. Further, the control unit 132 controls the electronic device 14 to write (update) the FW via the I/F unit 131 (transmits a message instructing update of the FW to the electronic device 14).

The flash memory 133 stores FW of the electronic device 13.

The storage unit 134 is a storage unit having an FS, and temporarily stores the FW supplied from the I/F unit 131 in the form of a file.

Since the electronic device 13 is provided with the storage unit 134 that temporarily stores the file of FW to be written in the flash memory 133, the electronic device 13 is an independent device. The electronic device 13 of the independent device can perform update processing of the FW of the electronic device 13 itself and can also perform update processing of a dependent device such as the electronic device 14 as an update processing device.

The electronic device 14 includes an I/F unit 141, a control unit 142, and a flash memory 143.

The I/F unit 141 is an I/F for exchanging signals with another electronic device connectable to the electronic device 14, for example, the electronic device 13. For example, the I/F unit 141 receives FW of the electronic device 14 transmitted from the electronic device 13, and supplies the FW to the control unit 142. In addition, the I/F unit 141 receives a message as a command from the electronic device 13 and supplies the message to the control unit 142. Further, the I/F unit 141 transmits a message as a response to the message as a command under the control of the control unit 142.

The control unit 142 includes a firmware check unit 142A, and performs control regarding update of the FW stored in the flash memory 143 in accordance with a message as a command from the I/F unit 141. For example, the control unit 142 receives the FW supplied from the I/F unit 141, and causes the firmware check unit 142A to perform a security check of the FW. The control unit 142 updates the FW of the electronic device 14 by writing the FW for which the security check has been normally completed by the firmware check unit 142A into the flash memory 143 serving as the FW storage area.

The flash memory 143 stores FW of the electronic device 14.

Since the electronic device 14 is not provided with a storage unit that temporarily stores the file of FW to be written in the flash memory 143, the electronic device 14 is a dependent device. The update processing of updating the FW of the electronic device 14 of the dependent device is performed by an independent device, for example, the electronic device 13 serving as an update processing device.

Here, for example, the electronic devices 11, 13, and 14 are accessories directly or indirectly connected to the electronic device 12 of the host device, and hereinafter, are also referred to as accessories A, B, and C, respectively.

Further, the electronic device 12 which is the host device and the independent device is also simply referred to as a host device.

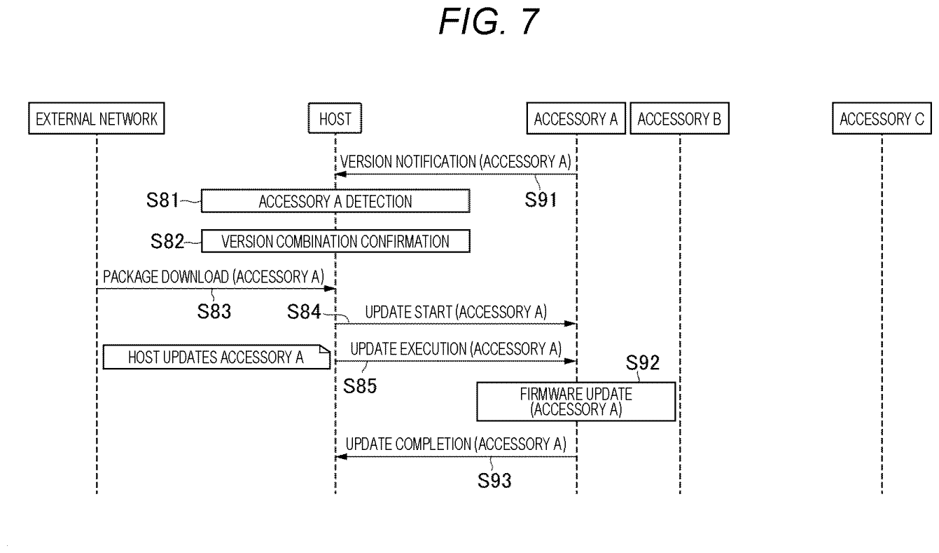

FIG. 7 is a diagram for explaining an example of the process of updating the FW of the accessory A in a case where the information processing system 10 includes the host device and the accessory A.

FIG. 7 illustrates an example of the process of updating the FW of the accessory A in a case where the host device and the accessory A are connected to configure the information processing system 10.

In step S91, the accessory A notifies the host device of the version or the like of the FW of the accessory A by transmitting a message including the version of the FW of the accessory A stored in the flash memory 113 to the host device.

The host device receives the message from the accessory A, and detects the presence (connection) of the accessory A, the FW version of the accessory A, and the like in step S81 on the basis of the message from the accessory A.

In step S82, the host device checks, on the basis of the version table, the combination of the latest versions with the guaranteed function as the combination of the versions of the host device and the FW of the accessory A. Then, the host device specifies the combination of the latest versions in which the function is guaranteed as a combination of FW versions that can be used in combination in the host device and the accessory A.

In a case where the version of the FW in the host device matches the version of the combination of the versions of the FW specified, but the version of the FW in the accessory A does not match the version of the combination of the versions of the FW specified, for example, in a case where the version of the FW in the accessory A is lower than the version of the FW in the combination of the versions of the FW specified, the FW for upgrading the FW in the accessory A is updated.

In this case, in step S83, the host device downloads the package (file) of the version of the FW of the accessory A in the specified combination of the versions of the FW from the data server 22 via the external network 21. Then, the host device temporarily stores the downloaded FW in the storage unit 124.

In step S84, the host device notifies the accessory A of the start of the update of the FW by transmitting a message indicating the start of the update of the FW to the accessory A. Thereafter, in step S85, the host device updates the FW of the accessory A with the FW stored in the storage unit 124. That is, the host device controls the accessory A such that the FW of the accessory A stored in the storage unit 124 is transmitted to the accessory A, and the FW updates the FW of the flash memory 113.

In step S92, the accessory A writes the FW transmitted from the host device into the flash memory 113 and updates the FW according to the control of the host device.

Upon completion of the update of the FW, the accessory A notifies the host device of completion of the update of the FW by transmitting a message indicating completion of the update of the FW to the host device in step S93.

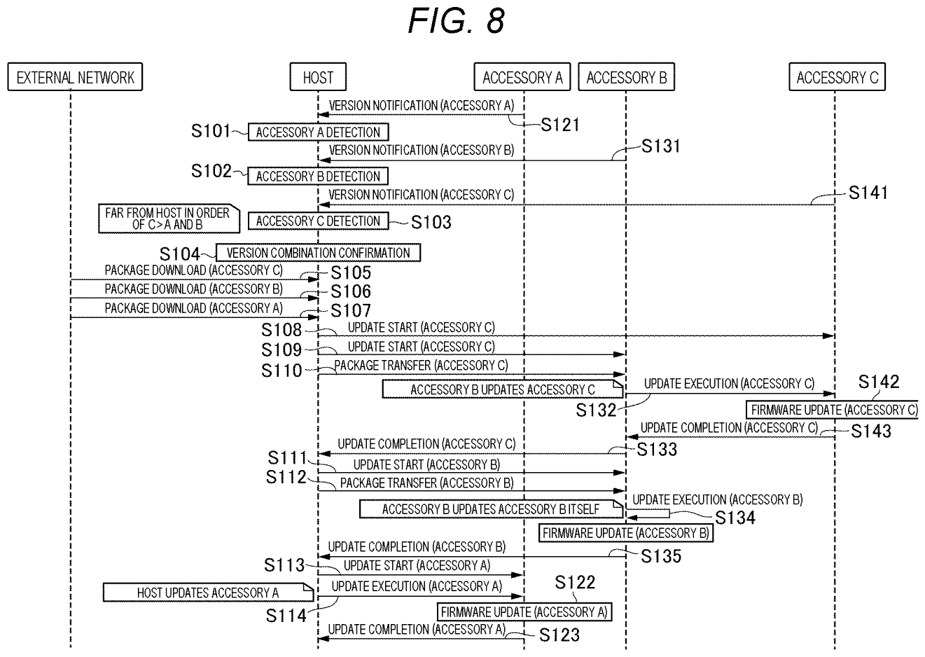

FIG. 8 is a diagram for explaining an example of the process of updating the FW of the accessories A to C in a case where the information processing system 10 includes the host device and the accessories A to C.

FIG. 8 illustrates an example of the process of updating the FW of the accessories A to C in a case where the host device is connected to each of the accessories A and B and the information processing system 10 is configured by connecting the accessory C to the accessory B.

In step S121, the accessory A notifies the host device of the version or the like of the FW of the accessory A by transmitting a message including the version of the FW of the accessory A stored in the flash memory 113 to the host device.

In step S131, the accessory B notifies the host device of the version or the like of the FW of the accessory B by transmitting a message including the version of the FW of the accessory B stored in the flash memory 133 to the host device.

In step S141, the accessory C transmits a message including the version of the FW of the accessory C stored in the flash memory 143 to the host device via the accessory B, thereby notifying the host device of the version of the FW of the accessory C and the like.

The host device receives the message from the accessory A, and detects the presence (connection) of the accessory A, the version of the FW of the accessory A, and the like in step S101 on the basis of the message from the accessory A. Further, the host device receives the message from the accessory B, and detects the presence of the accessory B, the version of FW of the accessory B, and the like in step S102 on the basis of the message from the accessory B. In addition, the host device receives the message from the accessory C, and detects the presence of the accessory C, the version of FW of the accessory C, and the like in step S103 on the basis of the message from the accessory C.

Further, the host device detects that the accessory C is distant from the host device (in the network tree structure, a hierarchy viewed from the host device is a lower hierarchy) in the order of the accessory A and the accessory B on the basis of the messages from the accessories A to C. The host device specifies the detected order as an order from a leaf node to a root node of the network tree structure.

In step S104, the host device checks the latest version combination of which the function is guaranteed as the combination of the versions of the host device and the FW of the accessories A to C on the basis of the version table. The host device specifies the checked combination as a combination of FW versions that can be used in combination in the host device and the accessories A to C.

In a case where the version of the FW in the host device matches the version of the combination of the versions of the FW specified, but the version of the FW in each of the accessories A to C does not match the version of the combination of the versions of the FW specified, for example, in a case where the version of the FW in each of the accessories A to C is lower than the version of the FW in the combination of the versions of the FW specified, the FW for upgrading the FW in each of the accessories A to C is updated.

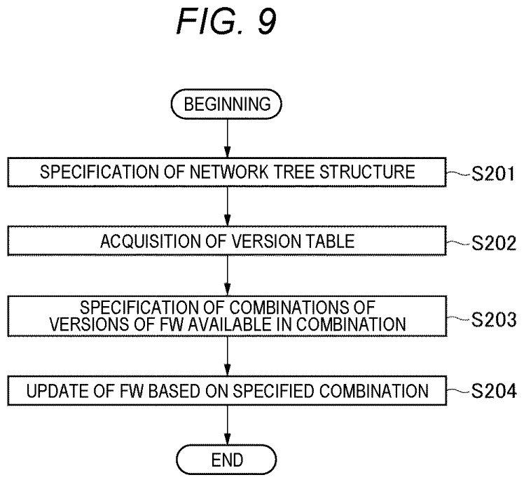

The update of the FW of the accessories A to C is performed in the order from the leaf node to the root node of the network tree structure, that is, in the order of the accessory C and then the accessories A and B. In the network tree structure, since the layers of accessories A and B are the same layer (first layer), the update of the FW of accessories A and B may be performed first. In FIG. 9, the FW of the accessories A to C in the order from the leaf node to the root node of the network tree structure is updated in the order of the accessories C, B, and A.

In steps S105, S106, and S107, the host device downloads the package (file) of the version of the FW of the accessories C, B, and A in the specified combination of the versions of the FW from the data server 22 via the external network 21, and temporarily stores the package in the storage unit 124 as necessary.

Thereafter, the FW of the accessories A to C is updated in the order from the leaf node to the root node of the network tree structure, here, in the order of the accessories C, B, and A.

First, the FW of the accessory C is updated. The update processing of the FW of the accessory C of the dependent device is performed by the accessory B of the independent device serving as the update processing device.

In step S108, the host device notifies the accessory C of the start of the update of the FW by transmitting a message indicating the start of the update of the FW to the accessory C via the accessory B. Further, in step S109, the host device notifies the accessory B of the start of the update of the FW of the accessory C by transmitting a message indicating the start of the update of the FW to the accessory B.

In step S110, the host device transmits (transfers) the FW of the accessory C downloaded from the data server 22 to the accessory B of the update processing device. The accessory B temporarily stores the FW of the accessory C from the host device in the storage unit 134.

In step S132, the accessory B updates the FW of the accessory C with the FW stored in the storage unit 134. That is, the accessory B transmits the FW of the accessory C stored in the storage unit 134 to the accessory C, and controls the accessory C to update the FW of the flash memory 143 by the FW.

In step S142, the accessory C writes the FW transmitted from the accessory B into the flash memory 143 and updates the FW according to the control of the accessory B.

Upon completion of the update of the FW, the accessory C notifies the accessory B of completion of the update of the FW by transmitting a message indicating completion of the update of the FW to the accessory B in step S143.

In step S133, the accessory B notifies the host device of completion of the update of the FW of the accessory C by transmitting a message indicating completion of the update of the FW of the accessory C to the host device according to the message from the accessory C.

Next, the FW of the accessory B is updated. The update processing of the FW of the accessory B of the independent device is performed by the accessory B itself as the update processing device.

In step S111, the host device notifies the accessory B of the start of the update of the FW by transmitting a message indicating the start of the update of the FW to the accessory B.

In step S112, the host device transmits the FW of the accessory B downloaded from the data server 22 to the accessory B. The accessory B temporarily stores the FW of the accessory B from the host device in the storage unit 134.

In step S134, the accessory B updates the FW in the flash memory 133 by the FW stored in the storage unit 134. That is, the accessory B writes the FW stored in the storage unit 134 into the flash memory 133 to update the FW.

Upon completion of the update of the FW, the accessory B notifies the host device of completion of the update of the FW by transmitting a message indicating completion of the update of the FW to the host device in step S135.

Thereafter, the FW of the accessory A is updated. The update processing of the FW of the accessory C of the dependent device is performed by the host device of the independent device as the update processing device.

In updating the FW of the accessory A, processes similar to those in steps S113, S114, S122, and S123 in FIG. 7 are performed in steps S84, S85, S92, and S93, respectively.

### Processing of Information Processing System 10

FIG. 9 is a flowchart for explaining an example of the process of updating the FW of the electronic device performed by the information processing system 10.

The process of updating the FW of the electronic device by the information processing system 10 can be periodically performed. In addition, the process of updating the FW of the electronic device by the information processing system 10 can be performed irregularly. For example, the process of updating the FW of the electronic device by the information processing system 10 can be performed when the user performs a predetermined operation or when there is a notification of release of a new version of the FW of the electronic device from the data server 22 or 23. Furthermore, for example, the process of updating the FW of the electronic device by the information processing system 10 can be performed when the configuration of the information processing system 10 is changed, for example, when a new electronic device constituting the information processing system 10 is connected, when an electronic device constituting the information processing system 10 is removed, or the like.

In step S201, the information processing system 10 specifies the network tree structure of the electronic device constituting the information processing system 10, and the process proceeds to step S202.

In step S202, the information processing system 10 acquires all the version tables stored in the data server 23 by downloading, and the process proceeds to step S203.

In step S203, the information processing system 10 specifies a combination of versions of FW that can be used in combination in the electronic devices constituting the information processing system 10 by using a device list and a version table, which will be described later, generated by specifying the network tree structure, and the process proceeds to step S204.

In step S204, the information processing system 10 updates the FW based on the specified combination by using the network tree structure as necessary, that is, updates the FW of the electronic device constituting the information processing system 10 to (the FW of) the version of the specified combination, and the process ends.

### Specification of Network Tree Structure

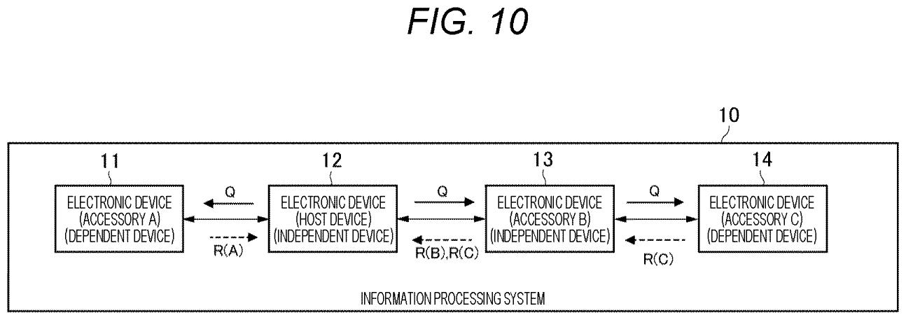

FIG. 10 is a diagram for explaining an example of a specific process of the network tree structure in step S201.

In the information processing system 10, the electronic device 12 of the host device broadcasts an inquiry message Q for inquiring another electronic device that the electronic device exists in the information processing system 10.

The electronic device that has received the inquiry message Q broadcasts the inquiry message Q. As a result, the inquiry message Q is transmitted in a chain-like manner.

The accessory X serving as the electronic device that has received the inquiry message Q broadcasts the inquiry message Q and returns a response message R (X) as a response to the inquiry message Q to the host device serving as the root node in the network tree structure. The response message R (X) is transmitted from the accessory X to the host device serving as the node of the root along the network tree structure.

The accessory X (=A, B, C) that returns the response message R (X) includes the identification information identifying the accessory X and the version of the FW of the accessory X in the response message R (X).

In addition, the response message R (X) includes parent node information and a number count value.

The parent node information is identification information of an electronic device that has directly received the response message R (X) from the accessory X that returns the response message R (X), that is, an electronic device represented by a node (hereinafter, also referred to as a parent node) one level higher than the node representing the accessory X that returns the response message R (X) in the network tree structure. The parent node information is included in the response message R (X) received from the accessory X by the electronic device that is the parent node of the accessory X that returns the response message R (X).

The number count value is a value for counting the number of electronic devices from the accessory X that returns the response message R (X) to the host device. The initial value of the number count value is, for example, 0. The electronic device increments the number count value by one when transmitting the response message R (X) to the electronic device serving as the node of the upper layer. The number count value included in the response message R (X) received by the host device is equal to the level (value) of the node representing the accessory X in the network tree structure.

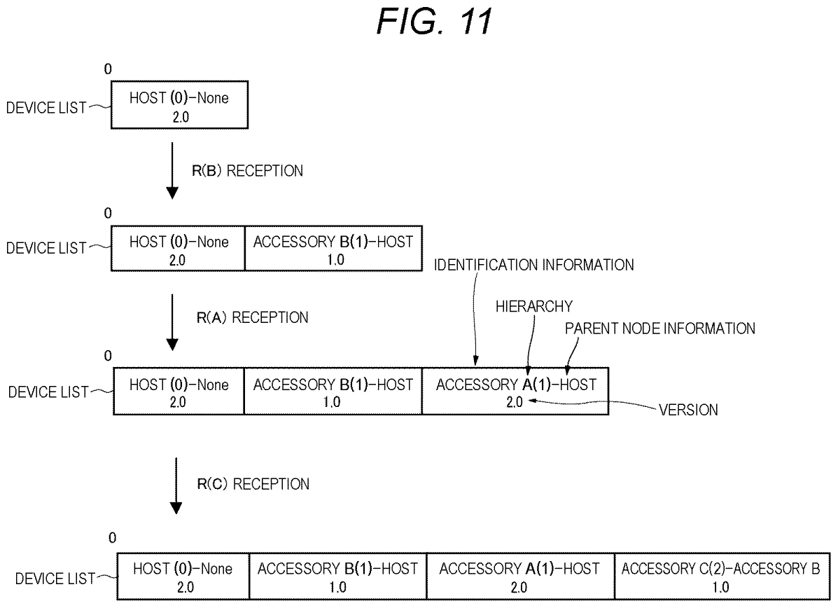

FIG. 11 is a diagram illustrating an example of a device list generated by specifying the network tree structure in step S201 of FIG. 9.

In the specification of the network tree structure, the host device (electronic device 12) generates the device list on the basis of the response message R (X) from the accessory X to the inquiry message Q. The device list is a list of the electronic devices 11 to 14 constituting the information processing system 10, and information of each of the electronic devices 11 to 14 is described (registered) in the device list. Examples of the information of the electronic device described in the device list include identification information of the electronic device, a hierarchy, parent node information (identification information of the electronic device serving as the parent node), and a version of FW.

The host device first describes information of the host device itself in the device list. That is, the host device describes identification information of the host device, a hierarchy of the host device, parent node information, and a version of the FW. In FIG. 11, the identification information of the host device is “host”, and the hierarchy of the host device is “0”. The parent node information is “None” indicating that there is no parent node, and the version of FW is “2.0”.

Thereafter, upon receiving the response message R (X), the host device describes (adds) information on the accessory X that has transmitted the response message R (X) to the device list on the basis of the response message R (X).

In FIG. 11, first, a response message R (B) from the accessory B is received. Then, the identification information “accessory B” of the accessory B, the level “1” of the accessory B, the parent node information “host” of the accessory B, and the version “1.0” of the FW are described in the device list as the information about the accessory B on the basis of the response message R (B).

Thereafter, a response message R (A) from the accessory A is received. Then, the identification information “accessory A” of the accessory A, the level “1” of the accessory A, the parent node information “host” of the accessory A, and the version “2.0” of the FW are described in the device list as the information about the accessory A on the basis of the response message R (A).

Finally, a response message R (C) is received from the accessory C. Then, the identification information “accessory” of the accessory C, the level “2” of the accessory C, the parent node information “accessory B” of the accessory C, and the version “1.0” of the FW are described in the device list as the information about the accessory C on the basis of the response message R (C).

Note that, here, for easy understanding of the description, a name is used as the identification information of the electronic device, but a unique identification (ID) or the like can be used as the identification information.

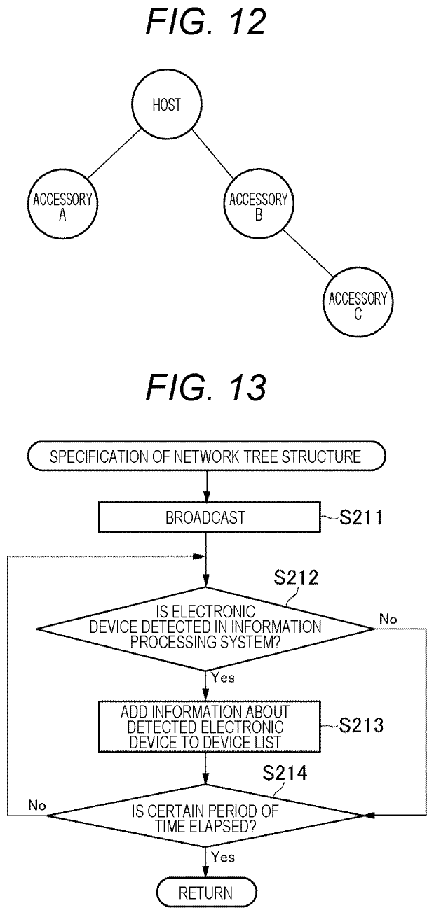

FIG. 12 is a diagram illustrating an example of a network tree structure specified by the specification of the network tree structure in step S201 in FIG. 9.

For example, the host device specifies the network tree structure of the electronic device constituting the information processing system 10 on the basis of the device list.

In the information processing system 10 of FIG. 6, a network tree structure is specified in which a node representing the host device is defined as a root node, a node representing the accessory A and a node representing the accessory B are connected to the node representing the host device, and a node representing the accessory C is connected to the node representing the accessory B, as illustrated in FIG. 12, on the basis of the device list in FIG. 11.

Note that, in a case where the update of the FW of the electronic device is performed in order from the electronic device serving as the leaf node of the network tree structure to the host device serving as the root node, the update order (hereinafter, also referred to as FW update order) for updating the FW of the electronic device can be set if the hierarchy of the nodes representing the electronic device is known, and thus, the update can be performed using either the network tree structure or the device list (FIG. 11).

FIG. 13 is a flowchart for explaining an example of the specific processing of the network tree structure in step S201 of FIG. 9.

In step S211, the host device broadcasts the inquiry message Q, and the process proceeds to step S212.

In step S212, the host device determines whether an electronic device has been detected in the information processing system 10. For example, in a case of receiving the response message R (X) to the inquiry message Q, the host device determines that the accessory X as the electronic device has been detected.

In a case where it is determined in step S212 that the electronic device has not been detected, the process skips step S213 and proceeds to step S214.

On the other hand, in a case where it is determined in step S212 that the electronic device has been detected, that is, in a case where the host device has received the response message R (X) from the accessory X serving as the electronic device, the process moves on to step S213.

In step S213, the host device adds information on the accessory X as the detected electronic device to the device list, and the process proceeds to step S214.

In step S214, the host device determines whether a certain period of time has elapsed since the start of detection of the electronic device, that is, since the broadcast of the inquiry message Q.

In a case where it is determined in step S214 that the certain period of time has not elapsed, the process returns to step S212, and similar processing is repeated thereafter.

On the other hand, in a case where it is determined in step S214 that the certain period of time has elapsed, the host device specifies the network tree structure on the basis of the device list, and the process returns.

Note that the specific processing of the network tree structure in step S201 can be performed by an electronic device other than the host device of the information processing system 10. In this case, the electronic device that has performed the specific processing of the network tree structure can transmit the device list and the network tree structure obtained by the processing to the host device.

### Version Table

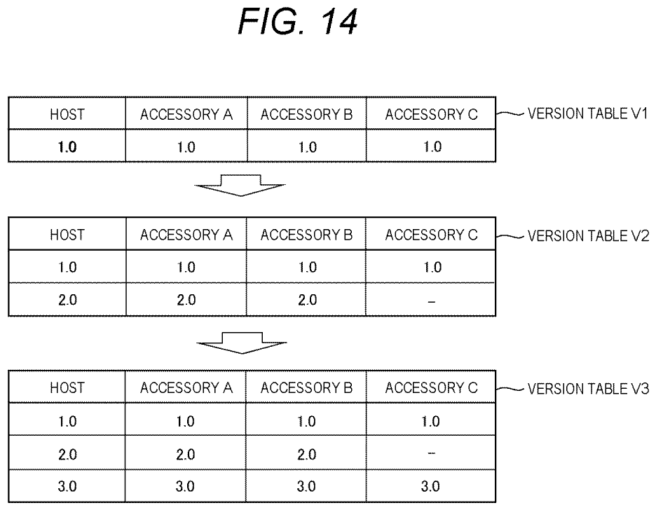

FIG. 14 is a diagram illustrating an example of a version table stored in the data server 23.

The version table is a table in which a combination of versions of the FW in which the function is guaranteed is described for a combination of electronic devices that can be combined as the information processing system 10. In the version table, for example, a combination of versions of FW whose functions are guaranteed is described in the same row.

The data server 23 stores version tables for various combinations of combinable electronic devices.

The first row of the version table describes a combination of combinable electronic devices. In each of the second and subsequent rows, a combination of versions of the FW in which the function is guaranteed is described for the combination of the electronic devices in the first row. Each of the second and subsequent rows is added according to release of a new version of the FW of the electronic device or the like, and accordingly, the version table is updated.

The version table of FIG. 14 is updated with version tables V1, V2, and V3. Note that the larger the version number, the newer the version.

According to the version table of FIG. 14, the function of the combination of the host device and the accessories A to C is guaranteed for the combination of the versions 1.0 of the respective FW. Further, the function of the combination of the host device and the accessories A and B is guaranteed for the combination of the versions 2.0 of the FW. In addition, the function of the combination of the host device and the accessories A to C is guaranteed for the combination of the versions 3.0 of the FW.

Note that the fact that the function is guaranteed for a combination of certain versions of the FW for a combination of certain electronic devices means that the function is guaranteed for a combination of certain versions of the FW for a combination in which one or more electronic devices are eliminated from the combination of the electronic devices. For example, as described above, in a case where the function of the combination of the host device and the accessories A to C is guaranteed for the combination of the versions 3.0 of the respective FW, the function of the combination in which the accessory C as one electronic device is eliminated from the combination of the host device and the accessories A to C, that is, the combination of the host device and the accessories A and B is also guaranteed for the combination of the versions 3.0 of the respective FW.

In step S202 of FIG. 9, the host device acquires the version table as described above by downloading it from the data server 23.

### Specification of Combinations of Versions of FW Available in Combination

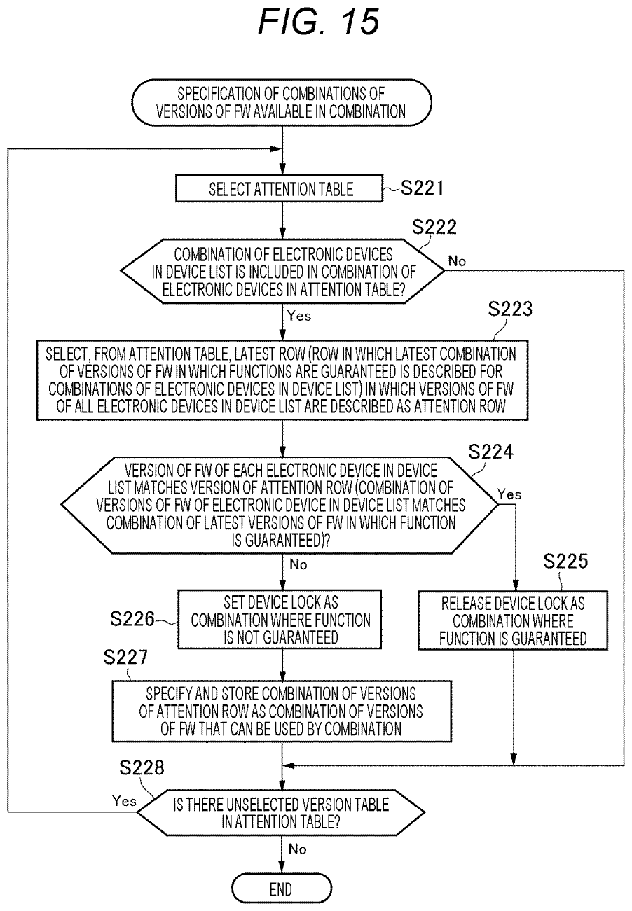

FIG. 15 is a flowchart for explaining an example of a process of specifying a combination of versions of FW that can be used in combination in step S203 of FIG. 9.

In step S221, the host device selects, as the attention table, one version table that has not yet been selected as the attention table among the version tables downloaded from the data server 23 in step S202 in FIG. 9, and the process proceeds to step S222.

In step S222, the host device determines whether the combination of the electronic devices in the device list is included in the combination of the electronic devices in the attention table. For example, if the device list is the device list described with reference to FIG. 11, it is determined whether the host device and the accessories A to C are described in the first row of the attention table.

In a case where it is determined in step S222 that the combination of the electronic devices in the device list is not included in the combination of the electronic devices in the attention table, the process skips steps S223 to S227 and proceeds to step S228.

In addition, in a case where it is determined in step S222 that the combination of the electronic devices in the device list is included in the combination of the electronic devices in the attention table, the process proceeds to step S223.

In step S223, the host device selects the latest row in which the versions of the FW of all the electronic devices in the device list are described from the attention table as the attention row. That is, the host device selects, as the attention row, a row in which the latest combination of the versions of the FW in which the function is guaranteed is described for the combination of the electronic devices in the device list in the attention table.

Then, the process proceeds from step S223 to step S224, and the host device determines whether the version of the FW of each electronic device in the device list matches the version of the attention row. That is, it is determined whether the combination of the versions of the FW of the electronic devices in the device list matches the combination of the latest versions of the FW in which the function is guaranteed.

In a case where it is determined in step S224 that the version of the FW of each electronic device in the device list matches the version of the attention row, that is, in a case where the combination of the versions of the FW of the electronic devices in the device list is the combination of the latest versions of the FW in which the function is guaranteed, the process proceeds to step S225.

In step S225, in a case where each electronic device of the information processing system 10 is device locked in step S226 described later, the host device unlocks the device, and the process proceeds to step S228.

On the other hand, in a case where it is determined in step S224 that the version of the FW of each electronic device in the device list does not match the version of the attention row, that is, in a case where the combination of the versions of the FW of the electronic devices in the device list is not the combination of the FW in which the function is guaranteed, the process proceeds to step S226.

In step S226, the host device locks each electronic device of the information processing system 10, and the process proceeds to step S227. The device lock means to restrict the electronic device from exhibiting its original function. For example, in a case where the electronic device is a drone, limiting the flight of the drone is a device lock.

In step S227, the host device specifies and stores the combination of the versions of the attention row as a combination of available FW versions, and the process proceeds to step S228.

In step S228, the host device determines whether there is a version table that has not yet been selected as the attention table among the version tables downloaded from the data server 23.

In a case where it is determined in step S228 that there is a version table that has not been selected as the attention table among the version tables downloaded from the data server 23, the process returns to step S221. Then, in step S221, one version table that has not yet been selected as the attention table among the version tables downloaded from the data server 23 is selected as the attention table, and the similar processing is repeated thereafter.

On the other hand, in a case where it is determined in step S228 that there is no unselected version table in the attention table among the version tables downloaded from the data server 23, the process ends (returns).

As described above, the latest row (a row in which a combination of the latest versions of the FW in which the function is guaranteed is described for the combination of the electronic devices in the device list) in which the versions of the FW of all the electronic devices in the device list are described is selected as the attention row from the attention table, and the combination of the versions of the attention row is specified as the combination of the available versions of the FW, and then the FW of the electronic device in the device list is updated to be the combination of the specified versions of the FW. As a result, the FW of the electronic device is updated to a combination of the latest versions of the FW in which the function is guaranteed.

Note that, here, the combination of the versions in the latest row in which the versions of the FW of all the electronic devices in the device list are described is specified as the combination of the available versions of the FW. That is, regarding the combination of the electronic devices in the device list, the combination of the latest versions of the FW in which the function is guaranteed is specified as a combination of available FW versions. However, in the case of the row in which the versions of the FW of all the electronic devices in the device list are described, the combination of the versions in any row can be specified as the combination of the available versions of the FW. That is, as long as the combination of the electronic devices in the device list is a combination of the versions of the FW in which the function is guaranteed, any combination of the versions can be specified as a combination of the available versions of the FW. For the combination of the electronic devices in the device list, which combination among the combinations of the versions of the FW in which the function is guaranteed is specified as the combination of the available versions of the FW can be determined according to, for example, the operation of the user.

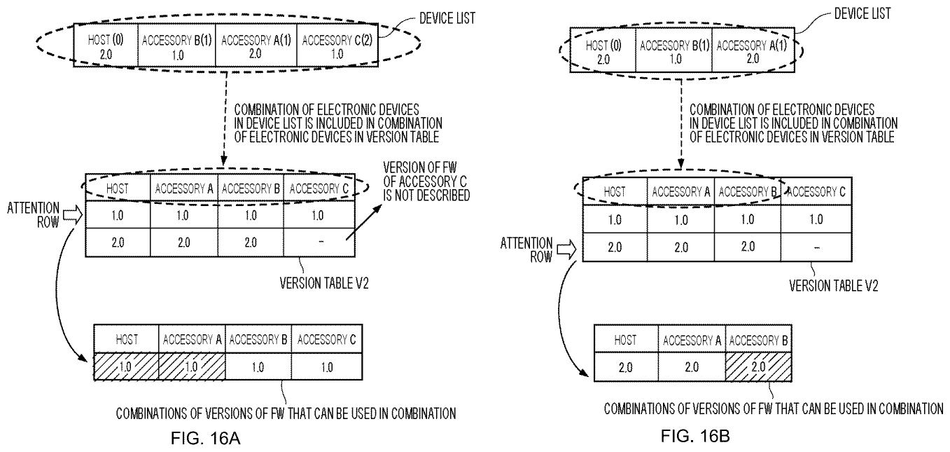

FIG. 16 is a diagram for explaining an example of the process of selecting the attention row in step S223 of FIG. 15 and specifying the combination of versions of FW that can be used in combination in step S227.

A of FIG. 16 illustrates an attention row selected in a case where the version table is the version table V2 of FIG. 14 and the information processing system 10 includes the host device and the accessories A to C.

B of FIG. 16 illustrates an attention row selected in a case where the version table is the version table V2 and the information processing system 10 includes the host device and the accessories A and B.

As described with reference to FIG. 14, the version table is a table in which a combination of versions of the FW in which the function is guaranteed is described in the same row for a combination of electronic devices combinable as the information processing system 10.

The version table V2 is a table in which a combination of versions of the FW in which the function is guaranteed for the combination of the host device and the accessories A to C is described. In the version table V2, in the second row, the function of the combination of the host device and the accessories A to C is guaranteed for the combination of the versions 1.0 of the respective FW. Further, in the third row, the function of the combination of the host device and the accessories A and B is guaranteed for the combination of the versions 2.0 of the respective FW.

In the version table V2, a combination of the host device and the accessories A to C is described in the first row.

Therefore, in both a case where the information processing system 10 includes the host device and the accessories A to C (A of FIG. 16) and a case where the information processing system includes the host device and the accessories A and B (B of FIG. 16), the combination of the electronic devices in the device list is included in the combination of the electronic devices in the version table V2.

In a case where the information processing system 10 includes the host device and the accessories A to C (A of FIG. 16), the row in which the latest combination of the versions of the FW in which the function is guaranteed is described for the combination of the host device and the accessories A to C is the second row in which 1.0 is described as the versions of the host device and the FW of the accessories A to C in the version table V2. Therefore, the second row of the version table V2 is selected as the attention row.

Note that, in the version table V2, the third row describes the versions of the host device and the FW of the accessories A and B, but does not describe the version of the FW of the accessory C. Therefore, the third row of the version table V2 cannot be said to be a row in which a combination of versions of the FW in which the function is guaranteed is described for the host device and the combinations of accessories A to C, and thus is not selected as the attention row.

In the attention row, the versions of the host device and the FW of the accessories A to C are all 1.0. In addition, in the device list, the versions of the host device and the FW of the accessories A to C are 2.0, 2.0, 1.0, and 1.0, respectively. Therefore, since the version of the FW of each electronic device in the device list does not match the version of the attention row, the combination of the versions of the attention row is specified as the combination of the versions of the FW that can be used in combination. In this case, in the update of the FW, the version of the FW of each of the host device and the accessory A is lowered from version 2.0 to version 1.0 as indicated by hatching in the drawing, and the version of the FW of each of the accessories B and C remains at version 1.0.

On the other hand, in a case where the information processing system 10 includes the host device and the accessories A and B (B of FIG. 16), the row in which the latest combination of the versions of the FW in which the functions are guaranteed is described for the combinations of the host device and the accessories A and B is the third row in which 2.0 is described as the versions of the host device and the FW of the accessories A and B in the version table V2. Therefore, the third row of the version table V2 is selected as the attention row.

In the attention row, the version of FW of each of the host device and the accessories A and B is 2.0. In addition, in the device list, the FW versions of the host device and the accessories A and B are 2.0, 2.0, and 1.0, respectively.

Therefore, since the version of the FW of each electronic device in the device list does not match the version of the attention row, the combination of the versions of the attention row is specified as the combination of the versions of the FW that can be used in combination. In this case, in the update of the FW, the FW of the host device and the FW of the accessory A remain in the version 2.0, and the FW of the accessory B is upgraded from the version 1.0 to the version 2.0 as indicated by hatching in the drawing.

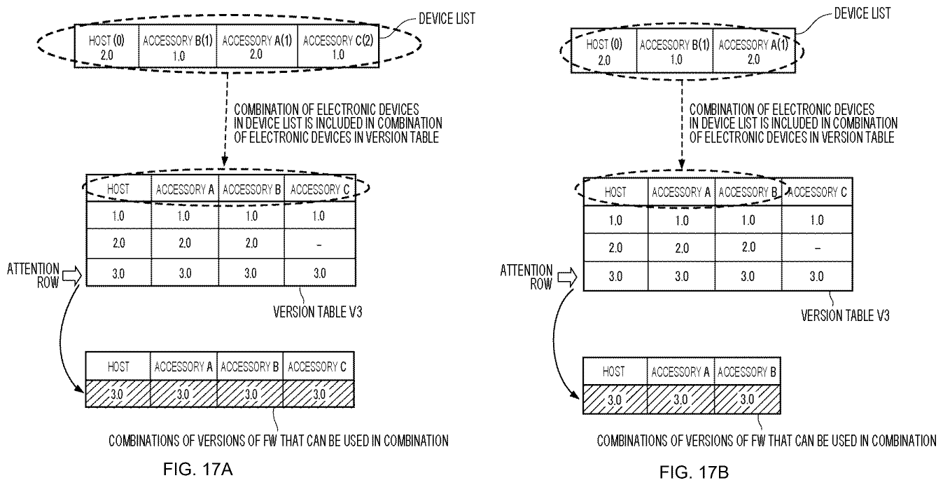

FIG. 17 is a diagram for explaining another example of the process of selecting the attention row in step S223 of FIG. 15 and specifying the combination of versions of FW that can be used in combination in step S227.

A of FIG. 17 illustrates an attention row selected in a case where the version table is the version table V3 and the information processing system 10 includes the host device and the accessories A to C.

B of FIG. 17 illustrates an attention row selected in a case where the version table is the version table V3 and the information processing system 10 includes the host device and the accessories A and B.

FIG. 17 is different from the case of FIG. 16 in that a version table V3 is used instead of the version table V2.

Similarly to the version table V2, the version table V3 is a table in which a combination of versions of the FW in which the function of a combination of the host device and the accessories A to C is guaranteed is described. The first to third rows of the version table V3 are configured similarly to the version table V2. In the version table V3, in the fourth row, the function of the combination of the host device and the accessories A to C is guaranteed for the combination of the versions 3.0 of the respective FW.

In the version table V3, similarly to the version table V2, a combination of the host device and the accessories A to C is described in the first row. Therefore, in both a case where the information processing system 10 includes the host device and the accessories A to C (A of FIG. 17) and a case where the information processing system includes the host device and the accessories A and B (B of FIG. 17), the combination of the electronic devices in the device list is included in the combination of the electronic devices in the version table V3.

In a case where the information processing system 10 includes the host device and the accessories A to C (A of FIG. 17), in the version table V3, the row in which the latest combination of the versions of the FW in which the function is guaranteed is described for the combination of the host device and the accessories A to C is the fourth row in which 3.0 is described as the versions of the host device and the FW of the accessories A to C. Therefore, the fourth row of the version table V3 is selected as the attention row.

In the attention row, the versions of the host device and the FW of the accessories A to C are all 3.0. In addition, in the device list, the versions of the host device and the FW of the accessories A to C are 2.0, 2.0, 1.0, and 1.0, respectively. Therefore, since the version of the FW of each electronic device in the device list does not match the version of the attention row, the combination of the versions of the attention row is specified as the combination of the versions of the FW that can be used in combination. In this case, in the update of the FW, as indicated by hatching in the drawing, the version of the FW of the host device and the accessory A is upgraded from version 2.0 to version 3.0, and the versions of the FW of the accessories B and C are upgraded from version 1.0 to version 3.0.

On the other hand, in a case where the information processing system 10 includes the host device and the accessories A and B (B of FIG. 17), in the version table V3, the row in which the latest combination of the versions of the FW in which the functions are guaranteed is described for the combinations of the host device and the accessories A and B is the fourth row in which 3.0 is described as the versions of the host device and the FW of the accessories A and B. Therefore, the fourth row of the version table V3 is selected as the attention row.

In the attention row, the version of FW of each of the host device and the accessories A and B is 3.0. In addition, in the device list, the FW versions of the host device and the accessories A and B are 2.0, 2.0, and 1.0, respectively.

Therefore, since the version of the FW of each electronic device in the device list does not match the version of the attention row, the combination of the versions of the attention row is specified as the combination of the versions of the FW that can be used in combination. In this case, in the update of the FW, as indicated by hatching in the drawing, the version of the FW of the host device and the accessory A is upgraded from version 2.0 to version 3.0, and the version of the FW of the accessory B is upgraded from version 1.0 to version 3.0.

### Update of FW Based on Specified Combination

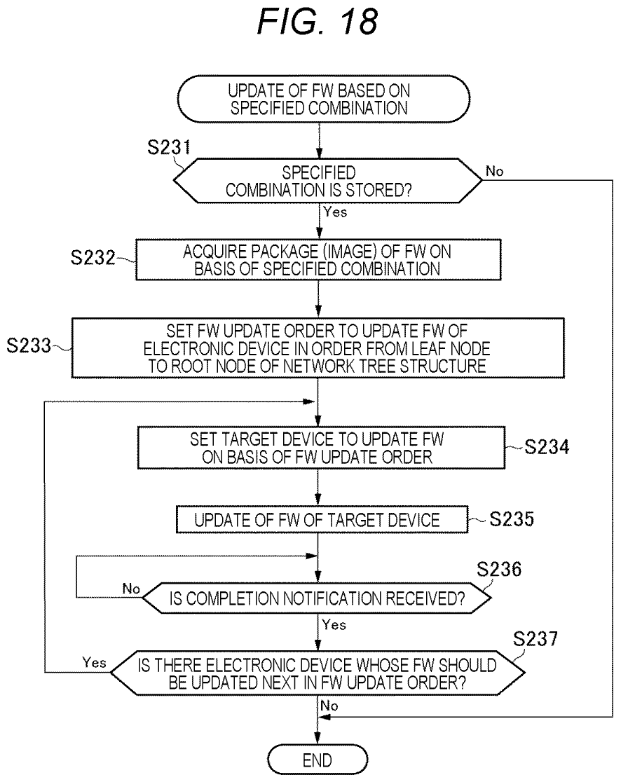

FIG. 18 is a flowchart for explaining an example of the process of updating the FW based on the specified combination in step S204 in FIG. 9.

In step S231, the host device determines whether the specified combination is stored.

In a case where it is determined in step S231 that the specified combination is not stored, that is, in a case where the specified combination is not stored in the specific process of the combination of versions of FW that can be used in combination in FIG. 15, the process ends.

The case where the specified combination is not stored is a case where it is determined in the specific process of the combination of versions of FW that can be used in combination in FIG. 15 that the combination of the versions of the FW of the electronic devices in the device list matches the combination of the latest versions of the FW in which the function is guaranteed. In a case where the combination of the versions of the FW of the electronic devices in the device list matches the combination of the latest versions of the FW in which the function is guaranteed, it is not necessary to update the FW of the electronic devices in the device list. Therefore, in the process of updating the FW based on the specified combination, the subsequent process including the update of the FW is skipped.

On the other hand, in a case where it is determined in step S231 that the specified combination is stored, that is, in a case where the specified combination is stored in the specific processing of the combination of versions of FW that can be used in combination in FIG. 15, the process proceeds to step S232.

In step S232, the host device acquires the package (image file) of the FW by downloading the package from the data server 22 on the basis of the specified combination, and the process proceeds to step S233. That is, among the electronic devices constituting the information processing system 10, the host device determines an electronic device whose current version of FW does not match the version of the specified combination as an electronic device whose FW is to be updated, and acquires the version of the FW of the electronic device in the specified combination. Note that the current version of the FW of the electronic device included in the information processing system 10 can be specified by referring to the device list.

In step S233, the host device sets the FW update order in which the FW of the electronic device is updated in the order from the leaf node to the root node of the network tree structure for the electronic device whose FW is to be updated, and the process proceeds to step S235.

In step S234, the host device sets (selects) a target device whose FW is to be updated among the electronic devices whose FW is to be updated on the basis of the FW update order, and the process proceeds to step S235.

In step S235, the information processing system 10 updates the FW of the target device set in the immediately preceding step S234, and the process proceeds to step S236.

In step S236, the host device determines whether or not there is a completion notification notifying completion of the update of the FW of the target device, and in a case where it is determined that there is no completion notification, the process returns to step S236.

In a case where it is determined in step S236 that there is the completion notification, that is, for example, in a case where the host device receives a message notifying completion of the update of the FW of the target device, the process proceeds to step S237.

In step S237, the host device determines whether there is an electronic device whose FW is to be updated next in the FW update order.

In a case where it is determined in step S237 that there is an electronic device whose FW is to be updated next in the FW update order, that is, in a case where there is an electronic device which is not yet set as the target device among the electronic devices whose FW is to be updated, the process returns to step S234, and the similar process is repeated thereafter.

On the other hand, in a case where it is determined in step S237 that there is no electronic device to which the FW is to be updated next in the FW update order, that is, in a case where the updating of the FW of all the electronic devices to which the FW is to be updated is completed, the process ends (returns).

### Update of FW of Target Device

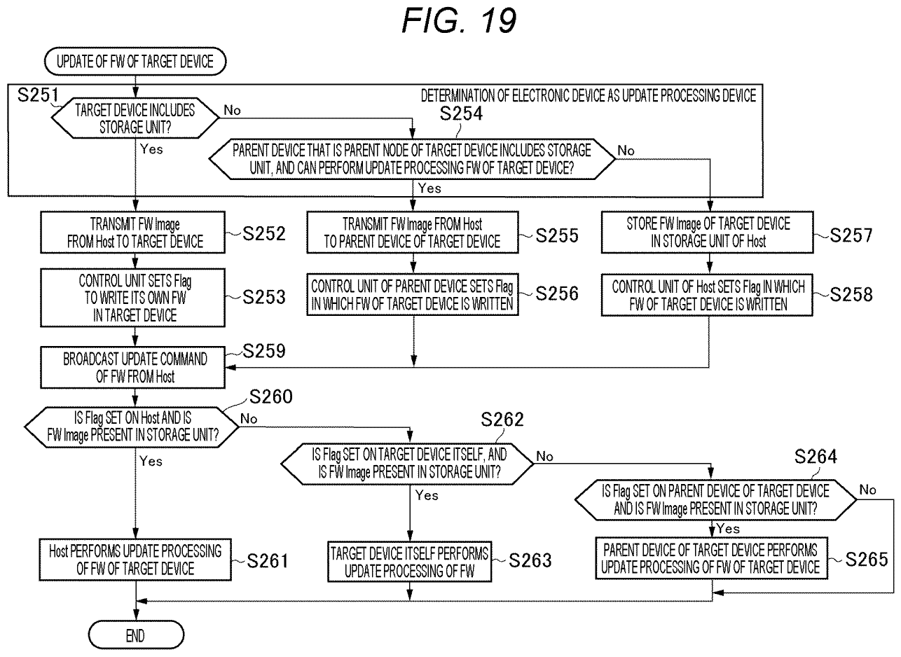

FIG. 19 is a flowchart for explaining a first example of the process of updating the FW of the target device in step S235 of FIG. 10.

In the update of the FW of the target device, first, the electronic device serving as the update processing device that updates the FW of the target device is determined.

The determination of the electronic device serving as the update processing device may be performed by the host device, or may be performed by an electronic device other than the host device, that is, the target device, an electronic device serving as a parent node of the target device (hereinafter, also referred to as a parent device), or an electronic device other than the target device and the parent device. Further, the determination of the electronic device to be the update processing device may be performed by each electronic device constituting the information processing system 10. Here, for example, it is assumed that the host device determines the electronic device to be the update processing device.

As a method of determining the electronic device to be the update processing device, for example, a first determination method can be adopted in which update function information related to an update function of the FW is stored in each electronic device, and the electronic device to be the update processing device is dynamically determined on the basis of the update function information. In the first determination method, for example, a host device or the like collects update function information from each electronic device, and dynamically determines an electronic device to be an update processing device on the basis of the update function information.

As the update function information of the electronic device, for example, information regarding the function of updating the FW, such as whether or not it is possible to perform the update processing of the FW of the electronic device itself (whether or not there is a storage unit that temporarily stores the FW), whether or not it is possible to perform the update processing of the FW of another electronic device, information of another electronic device that can be caused to perform the update processing of the FW, and information of another electronic device that can perform the update processing of the FW can be adopted.

As a method of determining the electronic device to be the update processing device, for example, a second determination method of preparing an update processing device list in which information on an update processing device capable of performing the update processing of the FW is described for each electronic device and determining the electronic device to be the update processing device on the basis of the update processing device list can be adopted.

For example, the update processing device list can be stored in the data server 23 and downloaded from the data server 23 to the host device.

In FIG. 19, the first determination method is adopted as a method of determining the electronic device to be the update processing device.

In FIG. 19, processing in steps S251 and S254 is performed as the determination of the electronic device to be the update processing device.

In step S251, the host device determines whether the target device includes the storage unit having the FS in which the FW is temporarily stored on the basis of the update function information.

In a case where it is determined in step S251 that the target device includes the storage unit that temporarily stores the FW, that is, in a case where the target device is the independent device, the host device determines the target device itself, which is the independent device, as the update processing device with respect to the target device, which is the independent device, and the process proceeds to step S252.

In step S252, the host device transmits the image file of the FW of the target device among the image files of the FW acquired from the data server 22 to the target device which is also the update processing device, and the process proceeds to step S253. In this case, the target device that is also the update processing device receives the image file of the FW from the host device, and temporarily stores the image file in the storage unit of the target device that is also the update processing device. Note that, in a case where the host device is the target device, the host device does not need to transmit the image file of the FW acquired from the data server 22 to the host device, and thus the host device does not transmit the image file of the FW of the host device acquired from the data Server 22 and stores the image file of the FW in the storage unit 124.

In step S253, the control unit (for example, the control unit 132 or the like of the electronic device 13 in FIG. 6) of the target device that is also the update processing device sets the own write flag indicating that the control to write its own FW is performed, and the process proceeds to step S259.

On the other hand, in a case where it is determined in step S251 that the target device does not include the storage unit that temporarily stores the FW, that is, in a case where the target device is a dependent device, the process proceeds to step S254.

In step S254, the host device determines, on the basis of the update function information and the network tree structure, whether or not the parent device serving as the parent node of the target device has the storage unit having the FS that temporarily stores the FW and can perform the update processing of the target device serving as the dependent device.

In a case where it is determined in step S254 that the parent device includes the storage unit that temporarily stores the FW and that the update processing for the target device can be performed, that is, in a case where the parent device is an independent device capable of performing the update processing for the target device, the host device determines the parent device which is the independent device capable of performing the update processing for the target device which is the dependent device as the update processing device, and the process proceeds to step S255.

In step S255, the host device transmits the image file of the FW of the target device among the image files of the FW acquired from the data server 22 to the parent device which is the update processing device of the target device, and the process proceeds to step S256. In this case, the parent device serving as the update processing device receives the image file of the FW from the host device, and temporarily stores the image file of the FW in the storage unit (for example, the storage unit 134 or the like of the electronic device 13 in FIG. 6) of the parent device serving as the update processing device.

In step S256, the control unit (for example, the control unit 132 or the like of the electronic device 13 in FIG. 6) of the parent device which is the update processing device of the target device sets the target device write flag indicating that the control to write the FW of the target device is performed, and the process proceeds to step S259.

On the other hand, in a case where it is determined in step S254 that the parent device does not include the storage unit that temporarily stores the FW, or in a case where it is determined that the parent device cannot perform the process of updating the target device, that is, in a case where the parent device is not the independent device or cannot perform the process of updating the target device even if the parent device is the independent device, for example, the host device determines the host device itself, which is also the independent device, as the update processing device for the target device, which is the dependent device, and the process proceeds to step S257.

In step S257, the host device temporarily stores the image file of the FW of the target device among the image files of the FW acquired from the data server 22 in the storage unit 124 of the host device itself determined by the update processing device, and the process proceeds to step S258.

In step S258, the control unit 122 of the host device which is also the update processing device sets the target device write flag indicating that the control to write the FW of the target device is performed, and the process proceeds to step S259.

In step S259, the host device broadcasts an update command message instructing to update the FW, and the process proceeds to step S260. Similarly to the inquiry message Q described with reference to FIG. 10, the broadcasted update command message is transmitted in a chain-like manner.

In step S260, the host device determines whether the target device write flag is set for the host device and the image file of the FW of the target device is stored in the storage unit 124 of the host device itself.

In a case where it is determined in step S260 that the target device write flag is set for the host device and the image file of the FW of the target device is stored in the storage unit 124, that is, in a case where the host device is the update processing device, the process proceeds to step S261.

In step S261, the host device performs update processing of updating the FW of the target device, and the process ends (returns). That is, the host device reads the FW of the target device stored in the storage unit 124 as the image file, transmits the FW to the target device, and writes the FW in the flash memory as the FW storage area of the target device. Note that, in a case where the host device is the target device, it is not necessary to transmit the image file of the FW of the host device stored in the storage unit 124 of the host device to the host device. Therefore, the host device writes the image file in the flash memory 123 of the host device without transmitting the FW of the host device which is the target device read from the storage unit 124.

On the other hand, in a case where it is determined in step S260 that the target device write flag is not set for the host device or the image file of the FW of the target device is not stored in the storage unit 124, that is, in a case where the host device is not the update processing device, the process proceeds to step S262.

In step S262, the target device determines whether the write flag of the target device itself is set and the image file of the FW of the target device is stored in the storage unit of the target device itself.

In a case where it is determined in step S262 that the write flag for the target device is set and the image file of the FW of the target device itself is stored in the storage unit of the target device, that is, in a case where the target device is the update processing device of the target device itself, the process proceeds to step S263.

In step S263, the target device that is also the update processing device receives the update command message broadcast in step S259, performs the update processing of updating the FW of the target device according to the update command message, and the process ends. That is, the target device reads the FW of the target device stored as an image file in the storage unit of the target device itself, and writes the FW in the flash memory as the FW storage area of the target device.

On the other hand, in a case where it is determined in step S262 that the write flag for the target device is not set or the image file of the FW of the target device is not stored in the storage unit of the target device itself, that is, in a case where the target device is not the update processing device, the process proceeds to step S264.

In step S264, the parent device of the target device determines whether the target device write flag is set for the parent device and the image file of the FW of the target device is stored in the storage unit of the parent device.

In a case where it is determined in step S262 that the target device write flag is set for the parent device and the image file of the FW of the target device is stored in the storage unit of the parent device, that is, in a case where the parent device of the target device is the update processing device, the process proceeds to step S265.

In step S265, the parent device which is the update processing device of the target device receives the update command message broadcast in step S259, performs the update processing of updating the FW of the target device according to the update command message, and the process ends. That is, the parent device reads the FW of the target device stored in the storage unit of the parent device as the image file, transmits the FW to the target device, and writes the FW in the flash memory as the FW storage area of the target device.

On the other hand, in a case where it is determined that the target device write flag is not set for the parent device or that the image file of the FW of the target device is not stored in the storage unit of the parent device, the process ends (returns).

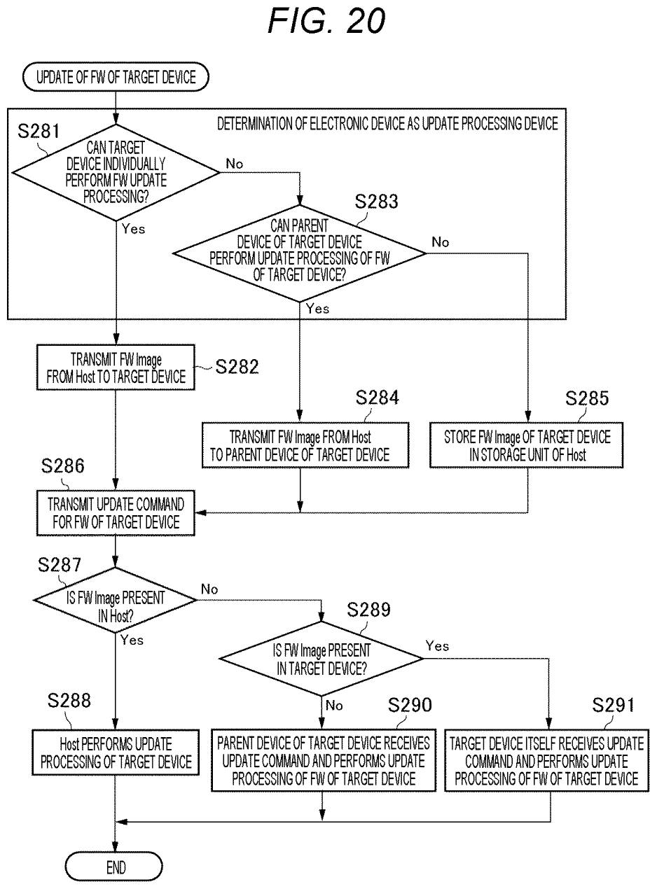

FIG. 20 is a flowchart for explaining a second example of the process of updating the FW of the target device in step S235 of FIG. 10.

In FIG. 20, the second determination method is adopted as a method of determining the electronic device to be the update processing device.

In FIG. 20, processing in steps S281 and S283 is performed as the determination of the electronic device to be the update processing device.

In step S281, the host device determines, on the basis of the update processing device list, whether the target device is an independent device capable of performing the process of updating the FW by the target device itself, that is, whether the target device becomes the update processing device of the target device.

In a case where it is determined in step S281 that the target device is an independent device capable of performing the update processing of the FW by the target device itself, the host device determines the target device itself, which is the independent device, as the update processing device, and the process proceeds to step S282.

In step S282, the host device transmits the image file of the FW of the target device among the image files of the FW acquired from the data server 22 to the target device which is also the update processing device, and the process proceeds to step S286. In this case, the target device that is also the update processing device receives the image file of the FW from the host device, and temporarily stores the image file in the storage unit of the target device that is also the update processing device. Note that, in a case where the host device is the target device, the host device does not need to transmit the image file of the FW acquired from the data server 22 to the host device, and thus the host device does not transmit the image file of the FW of the host device acquired from the data server 22 and stores the image file of the FW in the storage unit 124.

On the other hand, in a case where it is determined in step S281 that the target device cannot perform the update processing of the FW by the target device itself, that is, in a case where the target device is a dependent device, the process proceeds to step S283.

In step S283, the host device determines, on the basis of the update processing device list and the network tree structure, whether the parent device serving as the parent node of the target device can perform the process of updating the target device serving as the dependent device.

In a case where it is determined in step S283 that the parent device can perform the update processing for the target device, that is, in a case where the parent device is an independent device capable of performing the update processing for the target device, the host device determines, as the update processing device, the parent device that is the independent device capable of performing the update processing for the target device that is the dependent device, and the process proceeds to step S284.

In step S284, the host device transmits the image file of the FW of the target device among the image files of the FW acquired from the data server 22 to the parent device which is the update processing device of the target device, and the process proceeds to step S286. In this case, the parent device serving as the update processing device receives the image file of the FW from the host device, and temporarily stores the image file in the storage unit of the parent device serving as the update processing device.

On the other hand, in a case where it is determined in step S283 that the parent device cannot perform the update processing of the target device, that is, in a case where the parent device cannot perform the update processing of the target device even if the parent device is not the independent device or is the independent device, the host device determines the host device itself, which is also the independent device, as the update processing device for the target device, which is the dependent device, and the process proceeds to step S285.

In step S285, the host device temporarily stores the image file of the FW of the target device among the image files of the FW acquired from the data server 22 in the storage unit 124 of the host device itself determined by the update processing device, and the process proceeds to step S286.

In step S286, the host device broadcasts (transmits) an update command message instructing to update the FW, and the process proceeds to step S287. Similarly to the inquiry message Q described with reference to FIG. 10, the broadcasted update command message is transmitted in a chain-like manner.

In step S287, the host device determines whether the image file of the FW of the target device is stored in the storage unit 124 of the host device itself.

In a case where it is determined in step S287 that the image file of the FW of the target device is stored in the storage unit 124, that is, in a case where the host device is the update processing device, the process proceeds to step S288.

In step S288, the host device performs update processing of updating the FW of the target device, and the process ends (returns). That is, the host device reads the FW of the target device stored in the storage unit 124 as the image file, transmits the FW to the target device, and writes the FW in the flash memory as the FW storage area of the target device. Note that, in a case where the host device is the target device, it is not necessary to transmit the image file of the FW of the host device stored in the storage unit 124 of the host device to the host device. Therefore, the host device writes the image file in the flash memory 123 of the host device without transmitting the FW of the host device which is the target device read from the storage unit 124.

On the other hand, in a case where it is determined in step S287 that the image file of the FW of the target device is not stored in the storage unit 124, the process proceeds to step S289.

In step S289, the target device determines whether or not the image file of the FW of the target device is stored in the storage unit of the target device itself.

In a case where it is determined in step S289 that the image file of the FW of the target device is not stored in the storage unit of the target device itself, for example, in a case where the target device is a dependent device that does not include the storage unit including the FS itself, the parent device of the target device is determined as the update processing device of the target device, and the image file of the FW of the target device is stored in the storage unit of the parent device, the process proceeds to step S290.

In step S290, the parent device which is the update processing device of the target device receives the update command message broadcast in step S286, performs the update processing of updating the FW of the target device according to the update command message, and the process ends. That is, the parent device reads the FW of the target device stored in the storage unit of the parent device as the image file, transmits the FW to the target device, and writes the FW in the flash memory as the FW storage area of the target device.

On the other hand, in a case where it is determined in step S289 that the image file of the FW of the target device is stored in the storage unit of the target device itself, that is, in a case where the target device is the independent device and the update processing device of the target device itself, the process proceeds to step S291.

In step S291, the target device that is also the update processing device receives the update command message broadcast in step S286, performs the update processing of updating the FW of the target device according to the update command message, and the process ends. That is, the target device reads the FW of the target device stored as an image file in the storage unit of the target device itself, and writes the FW in the flash memory as the FW storage area of the target device.

Note that, in FIGS. 19 and 20, the parent device or the host device of the dependent device is determined as the update processing device of the dependent device for the dependent device, but the update processing device of the dependent device can determine any electronic device other than the parent device and the host device capable of performing the update processing of the FW of the dependent device. However, for example, in a case where the dependent device is connected to the parent device by USB or the like, it may be difficult for the electronic device other than the parent device to finely control the dependent device in the update processing of the FW of the dependent device.

### Description of Computer to Which Present Technology Is Applied

Next, the above-described series of processing can be performed by hardware or software. In a case where the series of processing is performed by software, a program constituting the software is installed in a general-purpose computer or the like.

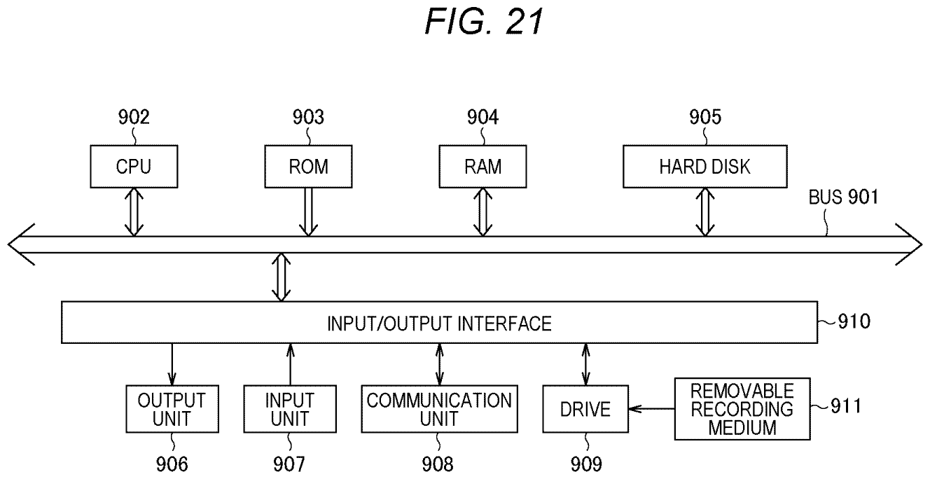

FIG. 21 is a block diagram illustrating a configuration example of an embodiment of a computer in which a program for executing the above-described series of processing is installed.

The program can be recorded in advance in a hard disk 905 or a ROM 903 as a recording medium built in the computer.

Alternatively, the program can be stored (recorded) in a removable recording medium 911 driven by a drive 909. Such a removable recording medium 911 can be provided as so-called packaged software. Here, examples of the removable recording medium 911 include a flexible disk, a compact disc read only memory (CD-ROM), a magneto optical (MO) disk, a digital versatile disc (DVD), a magnetic disk, a semiconductor memory, and the like.

Note that the program can be installed in the computer from the removable recording medium 911 as described above, or can be downloaded to the computer via a communication network or a broadcast network and installed in the built-in hard disk 905.

That is, for example, the program can be wirelessly transferred from a download site to the computer via an artificial satellite for digital satellite broadcasting, or can be transferred by wire to the computer via a network such as a local area network (LAN) or the Internet.

The computer incorporates a central processing unit (CPU) 902, and an input/output interface 910 is connected to the CPU 902 via a bus 901.

When a command is input by a user operating an input unit 907 or the like via the input/output interface 910, the CPU 902 executes a program stored in a read only memory (ROM) 903 according to the command. Alternatively, the CPU 902 loads the program stored in the hard disk 905 into a random access memory (RAM) 904 and executes the program.

As a result, the CPU 902 performs the processing according to the above-described flowchart or the processing performed by the configuration of the above-described block diagram. Then, the CPU 902 outputs the processing result from the output unit 906, transmits the processing result from the communication unit 908, or records the processing result in the hard disk 905 via the input/output interface 910, for example, as necessary.

Note that the input unit 907 includes a keyboard, a mouse, a microphone, and the like. Furthermore, the output unit 906 includes a liquid crystal display (LCD), a speaker, and the like.

Here, in the present specification, the processing performed by the computer according to the program is not necessarily performed in time series in the order described as the flowcharts. That is, the processing performed by the computer according to the program also includes processing executed in parallel or individually (for example, parallel processing or processing by an object).

Furthermore, the program may be processed by one computer (processor) or may be processed in a distributed manner by a plurality of computers. Furthermore, the program may be transferred to a remote computer and executed.

Furthermore, in the present specification, a system means a set of a plurality of components (apparatuses, modules (parts), or the like), and it does not matter whether or not all the components are in the same housing. Therefore, a plurality of apparatuses housed in separate housings and connected via a network and one apparatus in which a plurality of modules is housed in one housing are both systems.

Note that the embodiments of the present technology are not limited to the above-described embodiments, and various modifications can be made without departing from the gist of the present technology.

For example, the present technology can have a configuration of cloud computing in which one function is shared and processed in cooperation by a plurality of apparatuses via a network.

Furthermore, each step described in the above-described flowchart can be executed by one apparatus or can be shared and executed by a plurality of apparatuses.

Furthermore, in a case where a plurality of processes is included in one step, the plurality of processes included in the one step can be executed by one apparatus or can be shared and executed by a plurality of apparatuses.

Furthermore, the effects described in the present specification are merely examples and are not limited, and other effects may be provided.

Note that the present technology can have the following configurations.
<1>

An information processing method including
determining, from among a plurality of electronic devices connected, an electronic device to be an update processing device that performs update processing of software of a target device serving as an electronic device to which software is to be updated, in which
the update processing device performs update processing of software of the target device.
<2>

The information processing method according to <1>, in which
the plurality of electronic devices includes an independent device that is an electronic device capable of performing update processing of software by itself and a dependent device that is an electronic device in which update processing of software is performed by another electronic device.
<3>

The information processing method according to <2>, further including
determining the independent device as the update processing device.
<4>

The information processing method according to <2>or <3>, further including
determining, as the update processing device, the independent device capable of performing update processing of software of the dependent device for the dependent device.
<5>

The information processing method according to any one of <2>to <4>, in which
the plurality of electronic devices includes a host device that is an electronic device capable of communicating with an external network, and
in a case where a network topology of the plurality of electronic devices is expressed by a network tree structure which is a tree structure in which the host device is a root node, when the electronic device of a parent node which is a node at a level one level higher than a node of the dependent device in the network tree structure is the independent device capable of performing update processing of software of the dependent device, the electronic device of the parent node is determined as the update processing device.
<6>

The information processing method according to any one of <2>to <5>, in which
the independent device includes a storage unit that temporarily stores the software.
<7>

The information processing method according to any one of <1>to <6>, further including
determining an electronic device to be the update processing device when the electronic device is connected.
<8>

The information processing method according to any one of <1>to <7>, in which
the plurality of electronic devices includes a host device that is an electronic device capable of communicating with an external network, and
the host device acquires the software via an external network.
<9>

The information processing method according to any one of <1>to <8>, in which
the plurality of electronic devices includes a host device that is an electronic device capable of communicating with an external network, and
in a case where a network topology of the plurality of electronic devices is expressed by a network tree structure which is a tree structure in which the host device is a root node, update processing of software of the electronic device is performed in order from the electronic device which is a leaf node of the network tree structure toward the host device which is a root node.
<10>

The information processing method according to <9>, in which
the host device broadcasts a message, and specifies the network tree structure on the basis of a response message that the electronic device returns to the host device in response to the message.
<11>

The information processing method according to <10>, in which
the response message includes identification information for identifying the electronic device that returns the response message, identification information for identifying the electronic device of a parent node that is a node one level higher than a node of the electronic device that returns the response message in the network tree structure, and a level of the node of the electronic device that returns the response message in the network tree structure.
<12>

The information processing method according to any one of <1>to <11>, further including
determining an electronic device to be the update processing device on the basis of an update processing device list in which information of the update processing device capable of performing update processing of software of the electronic device is described.
<13>

The information processing method according to any one of <1>to <11>, further including
determining an electronic device to be the update processing device on the basis of update function information related to a function of updating software of the electronic device.
<14>

The information processing method according to any one of <1>to <13>, further including
specifying a combination of software that can be used in combination in the plurality of electronic devices on the basis of the plurality of electronic devices; and
updating the software of the electronic device such that the software of the plurality of electronic devices becomes the combination specified.
<15>

The information processing method according to <14>, further including
specifying a combination of software in which a function of each electronic device normally operates in a relationship with another electronic device as a combination of software that can be used in the combination.
<16>

The information processing method according to <15>, further including
specifying a combination of software that can be used in combination on the basis of a table in which a combination of software in which a function of each electronic device normally operates in a relationship with another electronic device is described.
<17>

The information processing method according to any one of <1>to <16>, in which
the plurality of electronic devices constitutes a drone system.
<18>

The information processing method according to any one of <1>to <17>, in which
the software is firmware (FW).
<19>

An electronic device capable of being one of a plurality of electronic devices, the electronic device including
a control unit configured to:
determine, from among a plurality of electronic devices connected, an electronic device to be an update processing device that performs update processing of software of a target device serving as an electronic device to which software is to be updated; and
cause the update processing device to perform update processing of software of the target device.
<20>

A program for causing a computer to execute processing of:
determining, from among a plurality of electronic devices connected, an electronic device to be an update processing device that performs update processing of software of a target device serving as an electronic device to which software is to be updated; and
causing the update processing device to perform update processing of software of the target device.

### REFERENCE SIGNS LIST

10 Information processing system
11 to 14 Electronic device
21 External network
22, 23 Data server
30 Drone system
31 Tablet
32 Transmitter
33 Drone
34 RTK
40 Vehicle system
41 PC
42 Vehicle
51 Interior I/F
52 Audio system
61 Exterior I/F
62 Proximity sensor
70 Drone system
71 Transmitter
72 Drone
73 RTK
111 I/F unit
112 Control unit
112A Firmware check unit
113 Flash memory
121 I/F unit
122 Control unit
122A Firmware check unit
122B Network control unit
123 Flash memory
124 Storage unit
125 Accessory detection unit
131 I/F unit
132 Control unit
132A Firmware check unit
133 Flash memory
134 Storage unit
141 I/F unit
142 Control unit
142A Firmware check unit
143 Flash memory
901 Bus
902 CPU
903 ROM
904 RAM
905 Hard disk
906 Output unit
907 Input unit
908 Communication unit
909 Drive
910 Input/output interface
911 Removable recording medium

1. An information processing method comprising
determining, from among a plurality of electronic devices connected, an electronic device to be an update processing device that performs update processing of software of a target device serving as an electronic device to which software is to be updated, wherein
the update processing device performs update processing of software of the target device.

2. The information processing method according to claim 1, wherein
the plurality of electronic devices includes an independent device that is an electronic device capable of performing update processing of software by itself and a dependent device that is an electronic device in which update processing of software is performed by another electronic device.

3. The information processing method according to claim 2, further comprising
determining the independent device as the update processing device.

4. The information processing method according to claim 2, further comprising
determining, as the update processing device, the independent device capable of performing update processing of software of the dependent device for the dependent device.

5. The information processing method according to claim 2, wherein
the plurality of electronic devices includes a host device that is an electronic device capable of communicating with an external network, and
in a case where a network topology of the plurality of electronic devices is expressed by a network tree structure which is a tree structure in which the host device is a root node, when the electronic device of a parent node which is a node at a level one level higher than a node of the dependent device in the network tree structure is the independent device capable of performing update processing of software of the dependent device, the electronic device of the parent node is determined as the update processing device.

6. The information processing method according to claim 2, wherein
the independent device includes a storage unit that temporarily stores the software.

7. The information processing method according to claim 1, further comprising
determining an electronic device to be the update processing device when the electronic device is connected.

8. The information processing method according to claim 1, wherein
the plurality of electronic devices includes a host device that is an electronic device capable of communicating with an external network, and
the host device acquires the software via an external network.

9. The information processing method according to claim 1, wherein
the plurality of electronic devices includes a host device that is an electronic device capable of communicating with an external network, and
in a case where a network topology of the plurality of electronic devices is expressed by a network tree structure which is a tree structure in which the host device is a root node, update processing of software of the electronic device is performed in order from the electronic device which is a leaf node of the network tree structure toward the host device which is a root node.

10. The information processing method according to claim 9, wherein
the host device broadcasts a message, and specifies the network tree structure on a basis of a response message that the electronic device returns to the host device in response to the message.

11. The information processing method according to claim 10, wherein
the response message includes identification information for identifying the electronic device that returns the response message, identification information for identifying the electronic device of a parent node that is a node one level higher than a node of the electronic device that returns the response message in the network tree structure, and a level of the node of the electronic device that returns the response message in the network tree structure.

12. The information processing method according to claim 1, further comprising
determining an electronic device to be the update processing device on a basis of an update processing device list in which information of the update processing device capable of performing update processing of software of the electronic device is described.

13. The information processing method according to claim 1, further comprising
determining an electronic device to be the update processing device on a basis of update function information related to a function of updating software of the electronic device.

14. The information processing method according to claim 1, further comprising
specifying a combination of software that can be used in combination in the plurality of electronic devices on a basis of the plurality of electronic devices; and
updating the software of the electronic device such that the software of the plurality of electronic devices becomes the combination specified.

15. The information processing method according to claim 14, further comprising
specifying a combination of software in which a function of each electronic device normally operates in a relationship with another electronic device as a combination of software that can be used in the combination.

16. The information processing method according to claim 15, further comprising
specifying a combination of software that can be used in combination on a basis of a table in which a combination of software in which a function of each electronic device normally operates in a relationship with another electronic device is described.

17. The information processing method according to claim 1, wherein
the plurality of electronic devices constitutes a drone system.

18. The information processing method according to claim 1, wherein
the software is firmware (FW).

19. An electronic device capable of being one of a plurality of electronic devices, the electronic device comprising
a control unit configured to:
determine, from among a plurality of electronic devices connected, an electronic device to be an update processing device that performs update processing of software of a target device serving as an electronic device to which software is to be updated; and
cause the update processing device to perform update processing of software of the target device.

20. A program for causing a computer to execute processing of:
determining, from among a plurality of electronic devices connected, an electronic device to be an update processing device that performs update processing of software of a target device serving as an electronic device to which software is to be updated; and
causing the update processing device to perform update processing of software of the target device.
